(19) United States
(12) Patent Application Publication
(10) Pub. No.: US 2005/0180574 A1
(43) Pub. Date: Aug. 18, 2005

(54) Method and system for document transmission

(76) Inventors: Derek Ritz, Ancaster (CA); Andrea Love, Richmond Hill (CA); Jeff Cummings, Burlington (CA); Rick Ensing, Rockwood (CA); Russell Baird, Mississauga (CA); Mike Hutson, Carlisle (CA)

Correspondence Address: BERESKIN AND PARR, 40 KING STREET WEST, BOX 401, TORONTO, ON, M5H 3Y2, CA

(21) Appl. No.: 11/029,479

(22) Filed: Jan. 6, 2005

Related U.S. Application Data
(60) Provisional application No. 60/541,038, filed on Feb. 3, 2004.
(60) Provisional application No. 60/543,264, filed on Feb. 11, 2004.
(60) Provisional application No. 60/615,940, filed on Oct. 6, 2004.

(51) Int. Cl. H04L 9/00

(52) U.S. Cl. 380/277

(57) ABSTRACT

A method and system for document transmission via communication networks is provided for. A user will create a document specifying the recipient upon a document and transmit it to the recipient such that they will not be required to specify the means by which the document is to be transmitted to the recipient and whom the document should be sent to. The document transmission system and method created a human and machine readable file representative of the document the user wishes to transmit and transmits it from the sender to the recipient such that it is transmitted securely.

### FIELD OF THE INVENTION

The present invention relates generally to a method and system for securely transmitting documents over network systems.

### BACKGROUND OF THE INVENTION

In the current business environment, businesses are always in constant communication with one another and business transactions will often require the transmittal of documentation between parties. For example, a party that sells goods and/or services, will often receive a purchase order detailing the goods and/or services that are required by the other party.

The contents of the documents that are transmitted between parties are of a great deal of importance. Therefore, a great deal of care will be taken to ensure that the information that is contained on these documents is correct, and secondly that these documents are sent to the intended party promptly, so that the particular transaction may be expeditiously furthered.

With respect to the transmittal of these documents from one party to another, various means may be employed. One of the more common means involves the use of facsimile services or mail/courier services. However, sending documents by means of facsimile or mail/courier services involves various inefficiencies. For example, to send a document by means of fax or mail/courier service is time consuming, and the sending party is generally not notified as a matter of course that the document was received and this may cause unnecessary delays.

With respect to a receiving party, who has received a document by means of fax or mail/courier service, manual work processes will be required to handle the incoming documents. These manual work processes prove to be time consuming and are not cost efficient. Also, there will often be a need to ensure that the contents of documents that are received are entered into some form of a computerized business system. The manual data entry of the contents of these documents is inefficient as it is prone to error, involves high labor costs and is time consuming.

Due to the various inefficiencies associated with the transmittal of documents by means of fax or mail/courier services, many businesses employ ANSI X.12 or EDIFACT-based Electronic Data Interchange (EDI) means in order to transmit data to intended parties electronically. EDI can simply be explained as a means of replacing paper-based documentation, relating to business, with electronic documentation.

However, EDI systems are fraught with problems as well. EDI deployments are typically very expensive undertakings, often costing tens of thousands of dollars and taking months to set up. Furthermore, despite the apparent standards regarding EDI document interactions, it is common for each trading partner/document relationship to require a separate implementation.

Business documents transmitted between trading partners often contain sensitive information. It is therefore imperative that information that is transmitted via electronic means be protected from possible interception or alteration in the course of transmission. As a result, one technique that is employed to ensure that information transmitted electronically is transmitted securely, is encryption.

Various encryption techniques may be used to ensure secure transmission of information. One such method is symmetric key encryption, which is also referred to as private-key encryption. In symmetric key encryption, information will first be encrypted by using a secret key. The secret key will only be shared between users who require the key to encrypt and decrypt information. The encrypted information is then transmitted to a recipient, who will decrypt the information using the secret key, and this will in turn regenerate the original information that was encrypted. In order for the recipient to decrypt the information, they are required to have the secret key. Therefore, it is of utmost importance that only those who are to be the senders or the intended recipients have the secret key. Therefore, secure channels must be used to share the key.

An encryption technique which deals with the problem of requiring that the key used in symmetric key encryptions be kept secret is public key encryption. In public key encryption, a private key and public key pair is used. The owner of these pair of keys will keep the private key secret and will share its public key with everyone. Therefore, when a sender wishes to send a document to a recipient, the sender will encrypt the document by using the public key of the recipient. The recipient will then receive this document and use their own private key to decrypt this document. Therefore, by using public key encryption, the private key need not be shared with anyone, but the pubic key may be shared with everyone.

The keys used for public key encryption are relatively large compared to those required for symmetric key encryption of comparable cryptographic strength. This is a necessity due to the modular math upon which public key cryptography is based. However, this has the effect of making public key encryption and decryption considerably more processor intensive compared to symmetric key encryption algorithms. Public key encryption is typically 2 to 3 orders of magnitude slower than symmetric key encryption of comparable cryptographic strength.

Methods, such as PGP, use a combination of symmetric and asymmetric encryption. As asymmetric encryption is generally time consuming, and generally requires a pair of very long keys to ensure security, PGP generates a new symmetric key called a session key, which is used to encrypt the data. PGP then encrypts the session key with the intended recipient's public key. The recipient then uses their private key to decrypt the session key, which is then used to decrypt the rest of the data. The session key is used only for one encryption session and is then discarded. Methods such as this, while addressing the shortcomings associated with standard encryption methods (time requirements), do not however provide for a means by which the intended recipient is ensured that the transmission did in fact, originate from an approved sender (i.e. authentication).

Therefore, there is a need for a system and method by which documents may be transmitted to intended parties without the inefficiencies that are associated with standard EDI practices, whereby a user will be required to undertake a minimal number of steps when transmitting documents to a recipient. There is also a need for a system and method by which document are transmitted, to be transmitted securely, such that authentication means are provided, and which are not as computationally intensive as other encryption algorithms

### SUMMARY OF THE INVENTION

The present invention provides a system and secure method for transmitting electronically created documents from a sender station to a recipient station.

In a first embodiment of the invention, a document is created at the sender station by a sender. A machine readable version of the document is created. The machine readable version includes document information extracted from the document. The document information includes one or more recipients to whom the document is intended to be sent. The machine readable version of the document is transmitted securely from the sender station to a server. The server transmits the machine readable version to one or more recipient stations, which are selected based on the recipients identified in the document information.

Optionally, a human readable version of the document may also be transmitted from the sender station to the server, and then from the server station to the one or more recipient stations together with the machine readable version of the document.

When the document is created at the sender station, it is sent to a virtual printer coupled to or installed at the sender station. The virtual printer extracts the document information in accordance with a document map that has been previously defined.

Document maps are defined by users of the embodiment. The document map specifies physical positions on a document where particular information may be found. For example, a document map will identify a physical region or area in which the recipient of the document is identified. The document map may also identify other regions in which other types of information are set out.

The present invention provides a system and method by which a document may be created. Typically, although not necessarily, a document map is created according to a document schema. The document schema identifies different types of information that may appear on a document. For example, a document schema for a purchase order will identify attributes that are typically found in different regions of a purchase order document, such as a recipient, purchase order number, products being ordered, quantities of each product ordered, the price of each product ordered, etc.

The physical layout of different regions of a specific document are mapped to different attributes defined in the schema, thereby defining the document map. Each region is defined by coordinates on the physical document, thereby associating the attributes with coordinates or coordinate range. The document map is recorded and is available to the virtual printer.

The machine readable version of the document is created when the document is printed to a virtual printer wherein a parsing method is employed. Upon the document being printed to the virtual printer a text table is created which includes all the text elements contained upon the document and the associated co-ordinates which may be in x,y form. Based on the document map, and the co-ordinates that are associated with an attribute, the text table is analyzed to determine the text that is associated with an attribute. The text that is associated with an attribute is concatenated such that it may be associated with an attribute identifier, such as an XML tag. These XML tags are used to create the machine readable file.

Subsequently, when a document is created is created and sent to the virtual printer, the virtual printer analyzes the document (in an electronic form) to identify information that appears in the different regions corresponding to the different attributes. The machine readable version includes information extracted from the different regions and may include tags defining the attribute to which the information corresponds. For example, the document information may be set out in an XML format and the recipient of the document may be identified using XML tags.

A human readable version may be generated by the virtual printer. The human readable version may formatted according to a common format, such as PDF.

The machine readable version and human readable version of the document comprise a data payload that is transmitted from the sender station to the recipient station through the server. The server has associated with it a private/public key pair. The server private key is only accessible by the server. The server public key is accessible by the sender and recipient. The sender station and recipient station each have associated with them a unique symmetric key, a copy of which is stored at the server.

When transmitting a data payload from a sender station to a recipient station, the sender station generates a one time session key that is used to ensure secure transmittal of the data payload. The one time session key is encrypted with the unique symmetric key associated with the sender. The data payload and the encrypted session key are encrypted with the session key. The session key is encrypted with the public key associated with the server. All of this encrypted data is then transmitted to the server.

Upon the encrypted data being received at the server, the server private key is employed to decrypt the session key that had been encrypted by the public key associated with the server. The session key that has been decrypted is used to decrypt the data payload. Based on information that has been transmitted to the server, a copy of the unique symmetric key associated with the sender is retrieved and used to decrypt the encrypted session key that had been part of the data payload. If the decryption is successful, the sender has then been authenticated, and it is ensured that the transmission did not originate from an unauthorized source.

The server then proceeds to perform the steps necessary to encrypt the appropriate data payload such that it may be transmitted securely to the recipient. The session key is first encrypted by the employing the private key associated with the server. The encrypted session key and the data payload are encrypted with the session key. The unique symmetric key associated with the recipient is retrieved and used to encrypt the session key. All of this encrypted data is transmitted to the recipient.

Upon this transmission being received at the recipient station, the session key that has been encrypted with the unique symmetric key associated with the sender is decrypted by the unique symmetric key. The session key is used to decrypt the data payload and encrypted session key. The encrypted session key is decrypted using the server public key, thus authenticating the server as the originator of the transmission ensuring that that the transmission has not originated from an unauthorized party.

The session key is a symmetric key, which will be smaller in length than a public/private key pair of comparable cryptographic strength. As a result, the encryption and decryption of the data payload can typically be performed more quickly than if the session key is the same length as the PKI keys.

If the system is implemented within a network that utilizes a public key infrastructure (PKI), only the server's public/private key pair need to be compliant with the public key infrastructure. The session key is used only for the session and itself is encrypted using the server keys.

The secure method of transmitting a data payload may be used to transmit any data and is not limited to use within the system described above

One aspect of the present invention is directed to a method of transmitting a data payload from a sender station to a recipient station . The method comprises the steps of assigning a sender ID key to one or more stations belonging to a sender; assigning a recipient ID key to one or more stations belonging to a recipient; and assigning a server public key to a server; assigning a server private key to the server, wherein the server private key and the server public key are a complementary pair of keys. The steps undertaken at the sender involve generating a session key; encrypting the session key with the server public key to produce a first sender encrypted session key; encrypting the session key with the sender ID key to produce a second sender encrypted session key; encrypting the data payload and the second encrypted session key with the session key to produce a sender encrypted payload; and transmitting the sender encrypted payload and the first sender encrypted session key to the server. The steps undertaken at the server involve decrypting the first sender encrypted session key with the server private key to obtain a first server decrypted session key; decrypting the sender encrypted payload with the first server decrypted session key to obtain the payload and the second sender encrypted session key; determining the sender associated with the payload based on information transmitted from sender; decrypting the second sender encrypted session key with the sender ID key to obtain a second server decrypted session key; comparing the first server decrypted session key to the second server decrypted session key; and if the result of the comparison is that the first and second server decrypted session keys are identical, then accepting the transmission as having originated from the sender station. Another aspect of the present invention is directed to a method of transmitting documents from a sender station to a recipient station. The method comprises creating a document at a sender station and specifying recipient information upon said document; creating files representative of said document; identifying said recipient information upon said document; transmitting said representative files and said recipient information to a server; receiving said representative files and said recipient information at said server; determining at said server an electronic address associated with said recipient information; and transmitting from said server to a recipient said representative files via said electronic address.

Another aspect of the present invention is directed to a method for creating a document map for a document, wherein the document is of a document type, the method comprises: defining a document schema, wherein the document schema contains attributes associated the document type; and mapping different regions of the document and correlating each mapped region to an attribute.

Another aspect of the present invention is directed to a method of transmitting documents from a sender to a recipient. The method comprises: creating a document at a sender station and specifying recipient information upon said document; creating a machine readable version of the document, wherein the machine readable version identifies the recipient based on the recipient information; transmitting said machine readable version of the document, wherein said server receives said recipient information and said machine readable version and determines an electronic address associated with said recipient, and transmits said representative files to said recipient via said electronic transmission means.

Another aspect of the present invention is directed to method of parsing a document to create a machine readable version of the document, the method comprising: receiving the document in an electronic form; extracting text elements of the document and recording the coordinates of each text element; comparing the coordinates of each extracted text element with regions defined in a document map; identifying an attribute for each extracted text element based on the comparison; and recording each extracted text element according to its attribute in the machine readable file.

### BRIEF DESCRIPTION OF THE DRAWINGS

For a better understanding of the present invention, and to show more clearly how it may be carried into effect, reference will now be made by way of example, to the accompanying drawings which show preferred embodiments of the present invention, and in which:

FIG. 1 is a schematic diagram illustrating the conventional methods by which documents are transmitted between parties;

FIG. 2 is a schematic diagram illustrating a high-level overview of the document transmission system;

FIG. 3 is a schematic diagram illustrating the components of the application;

FIG. 4 is a schematic diagram illustrating the components of the document transmission system of FIG. 2 in greater detail;

FIG. 5 is an example of a type of document that may be transmitted via the document transmission system.

FIG. 6 is a block diagram highlighting the various attributes contained in a purchase order.

FIG. 7 is a flowchart illustrating the steps required to be undertaken by a user in order to use the document transmission system .

FIG. 8 is a screenshot of an application printer, among the choice of printers.

FIG. 9 is a flowchart illustrating a document mapping method.

FIG. 10 is a screenshot illustrating various options that are presented to the user in the mapping method.

FIG. 11 is a screenshot illustrating the options in respect of choosing a particular document type to map that are presented to a user

FIG. 12 is a screenshot illustrating the user specifying the location of an attribute upon a document.

FIG. 13 is a schematic diagram illustrating the various fields contained within a document field map.

FIG. 14 is a diagram illustrating a grid overlaid upon a document, which is used to specify co-ordinates, at which attributes are located.

FIG. 15 is a screenshot illustrating the various optional attributes that a user may specify the locations of upon a document.

FIG. 16 is a schematic diagram illustrating the various fields contained within a document section map.

FIG. 17 is a screenshot illustrating the mapping of an attribute that does not occur at the same location upon all documents of the same type.

FIG. 18 is screenshot illustrating the list of attributes shown to a user, that may uniquely identify the document.

FIG. 19 is a screenshot illustrating the user selecting an attribute or attributes that may serve as a unique line identifier.

FIG. 20 is a screenshot illustrating the options presented to a user upon the conclusion of the mapping method.

FIG. 21 is a flowchart illustrating the steps of a document transmittal method.

FIG. 22 is a screenshot illustrating the screen that a user views when attempting to print the purchase order to the mapper printer.

FIG. 23 is a screenshot illustrating a document transmittal window that is shown to a user.

FIG. 24 is a screenshot illustrating the results of a directory search requested by a user.

FIG. 25 is a screenshot of an invitation a user may send to a party via the document transmission system.

FIG. 26 is a screenshot of a transmission status window that is displayed to a user after they have transmitted a document via the document transmission system.

FIG. 27 is schematic diagram of the fields contained within an audit record database.

FIG. 28 is a screenshot of an e-mail message that is received by an intended recipient.

FIG. 29 is a screenshot of a recipient option window.

FIG. 30 is a schematic diagram illustrating the keys used in the encryption method.

FIG. 31 is a flowchart illustrating the steps of an encryption method.

FIG. 32 is a schematic diagram illustrating the results of the various encryption steps that have been undertaken at the sender's station.

FIG. 33 is a schematic diagram illustrating the results of the various encryption steps that have been undertaken at the server.

FIG. 34 is a flowchart illustrating the steps of a status reply method.

FIG. 35 is a schematic diagram illustrating the fields which are contained in the transmission database.

FIG. 36 is a flowchart illustrating the steps of a parsing method.

FIG. 37 is a schematic diagram of an extracted text table and its associated fields.

FIG. 38 is a schematic diagram of a body map table and its associated fields.

### DETAILED DESCRIPTION OF THE INVENTION

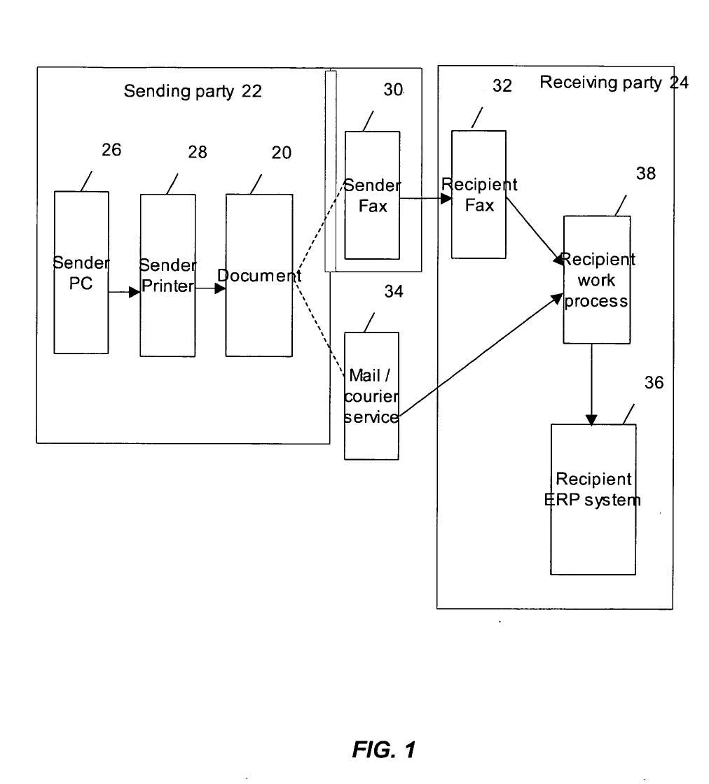

In business relationships, it is necessary for documents to be transmitted between parties. Documents of various types may be transmitted between parties. For example, they may be purchase orders, sales orders, bills of ladings, bills of sale, or even referral forms that physicians are required to send to other physicians. Reference is now made to FIG. 1, where a block diagram illustrating the conventional methods by which documents are transmitted between parties is shown.

In FIG. 1 it is shown that a document 20 that is to be transmitted from a sending party 22 to a receiving party 24 is prepared upon a computer 26. Once prepared, the sending party 22 prints the document 20 to a printer 28. The sending party 22 may then make use of various methods to transmit the document 20 to the receiving party 24. A common method that is employed, is for the document 20 to be sent by facsimile, where the sending party 22 transmits the document from a sender fax 30 specifying that it is to be received by a recipient fax 32.

Another method that is employed to transmit the document 20 is for the document 20 to be sent via a mail/courier service 34. Regardless of the method employed for transmittal of the document 20, once the receiving party 24 is in receipt of the document 20, there will often be a need to make use of a computerized system 36, so that the specifics that are contained upon the document 20 may be recorded. The information that is contained upon the document 20 is generally entered into the computerized system 36 by means of a manual work process 38, whereby manual data entry is performed and the document 20 is analyzed and all appropriate information is entered into the computerized system 36.

The present invention will now be described more fully hereinafter with reference to the accompanying drawings, in which preferred embodiments of the invention are shown.

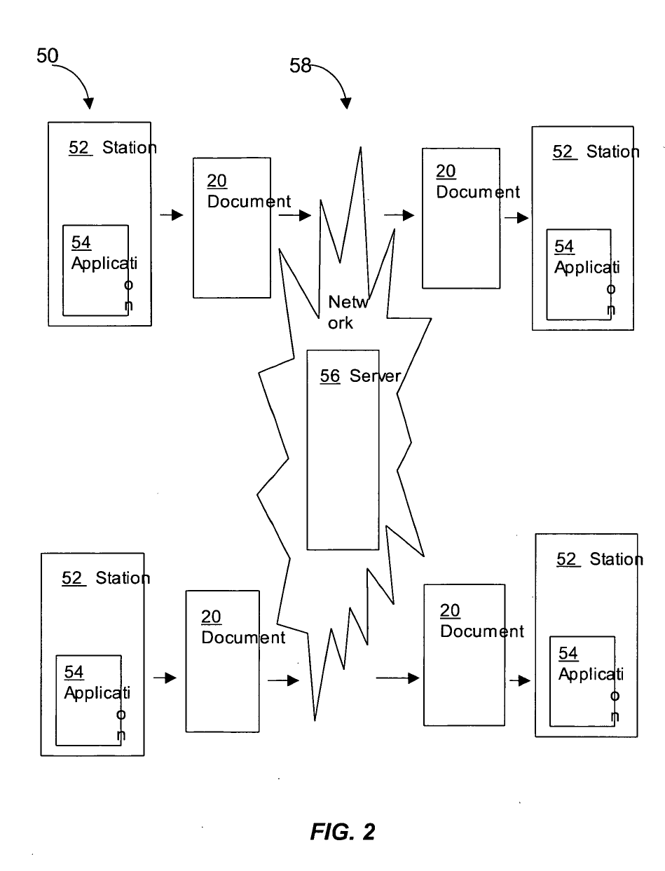

A system, according to one embodiment of the invention, is designed for the transmission of documents over data networks. In a particular embodiment of the invention, the system is configured such that documents may be transmitted between stations over a data network. Reference is now made to FIG. 2, where a block diagram illustrating the components of a document transmission system 50, according to the present invention, is shown. The document transmission system 50 of the present invention allows for secure and efficient transmittal of documents 20 between parties. The document transmission system 50 involves the creation of documents 20 that are to be sent to other parties upon stations 52. Each station 52 is connected to, or has installed upon it, an application 54. Once a document 20 has been created, a party invokes the application 54 to ensure secure and efficient transmittal of the document 20, as is described in further detail below. The application 54 causes various representations of the document 20 to be created and transmitted to a server 56 in a secure manner, from where the various representations of the document 20 are transmitted to the intended recipient party via e-mail or some other means of electronic delivery (such as ftp, or http post forward), which are referred to as electronic transmission means. The document 20 is transmitted to and from the server 56 via a communication network 58.

The stations 52 may be any type of computer apparatus that allows for connectivity to a network and that allows for the application 54 to be accessed. The stations 52 may be personal computers, laptops, slim line computers, a server, or any other suitable apparatus. The station 52, refers to a computer or other processing device, that will typically, but not necessarily be associated with a user.

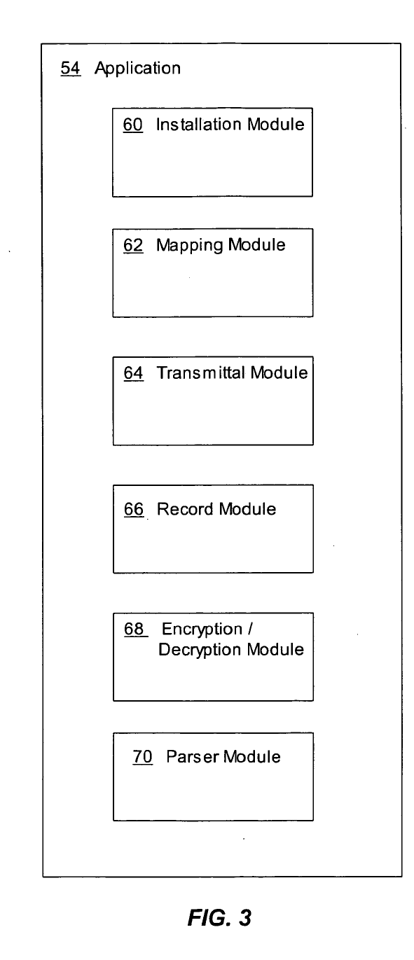

The application 54 is a software application that is installed upon a station 52 and allows for the secure and efficient transmittal of documents 20 between parties. Reference is now made to FIG. 3, where the constituent components of the application 54 are shown. The application 54 comprises an installation module 60, a mapping module 62, a transmittal module 64, a record module 66, an encryption/decryption module 68 and a parser module 70. As will be understood by one skilled in the art, the application 54 and its constituent components may be embodied in the form of hardware, software, or a combination of both.

The installation module 60 allows for the application to be installed upon a station 52. The mapping module 62 is adapted to allow the user to specify the physical locations upon their documents 20, wherein certain information upon a document may be found. The transmittal module 64 is adapted to allow for documents 20 to be transmitted over data networks. The record module 66 is adapted to keep records of all transmittals of documents that are performed through the document transmission system 50. The encryption/decryption module 68 causes any transmission sent via the document transmission system 50 to be transmitted such that they are encrypted, and allows for the transmission to be decrypted upon the transmission having reached its intended destination. The parser module 70 creates various machine and human readable representations of the document 20, which the user wishes to be transmitted via the document transmission system 50. The application 54, and more specifically, the components of the application 54 as have been mentioned here, is further described with reference to the operation of the system 50. Whereas the modules are shown here as separate modules for purposes of clarity, it should be understood that the functionality of the above mentioned modules may be combined.

The server 56 may be any computer apparatus that can be connected to a network, and that has sufficient storage means. The server 56 receives various representations of documents 20 that are sent by users and appropriately processes them as is described in further detail below, and then transmits them to the intended recipient party.

The communication network 58 may be the Internet, or any other communication system or means through which data can be communicated between stations 52.

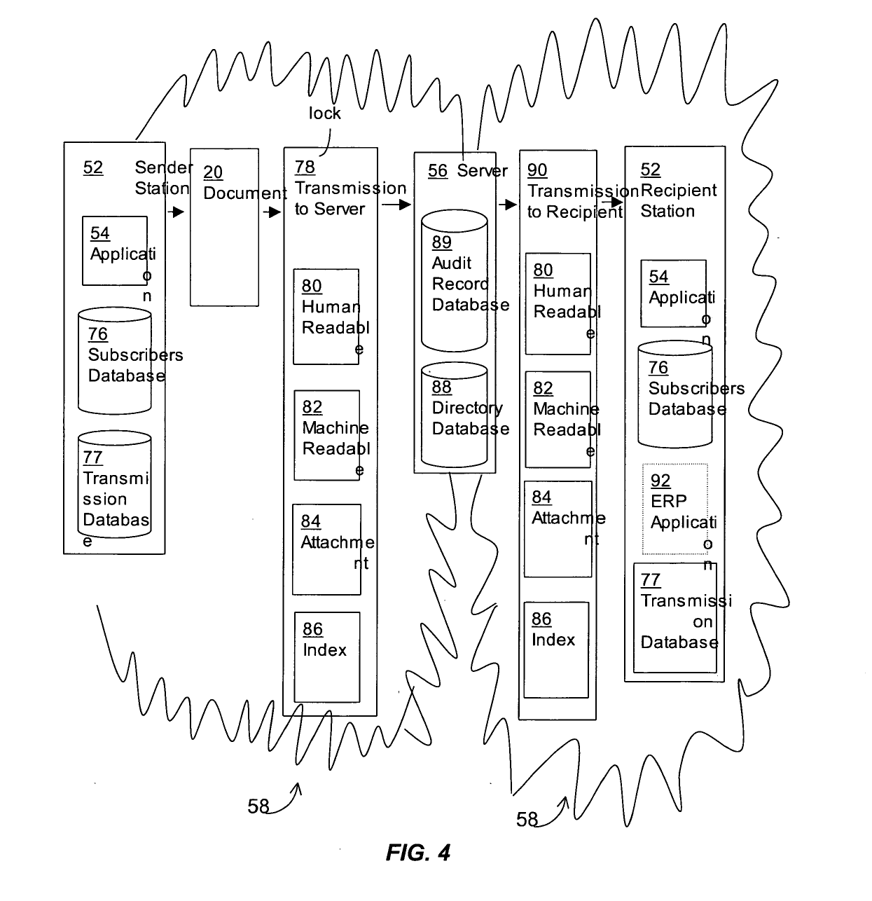

Reference is now made to FIG. 4, where a schematic diagram illustrating the document transmission system 50 of FIG. 2 in greater detail is shown. A station 52, that transmits documents 20 by means of the document transmission system 50, has associated with it a subscribers database 76. The subscribers database 76 is operated by the record module 66, such that the subscriber database 76 keeps a record of all users of the document transmission system 50 with whom the user transmits and or receives documents 20 via the document transmission system 50. A station 52 also has associated with it a transmission database 77, which contains records of all inbound and outbound transmissions via the document transmission system, and is described in further detail below.

Once a document 20 has been created, a user invokes the application 54 in order to transmit the document 20. The user, upon invoking the application 54, is not required to specify how and to whom the document 20 is to be sent. The document transmission system 50 identifies the recipient of the document 20 by means of examining the document 20 that has been prepared. The user is not required to undertake any further actions with respect to specifying a recipient, aside from ensuring that a recipient has been identified upon the document 20 that has been created. As a result of the application 54 being invoked, the parser module 70 causes various representations of the document 20 to be created and the various representations, along with other data, are transmitted to a server 56 by the transmittal module 64. The representations of the document 20, along with any other data that is transmitted from a sender's station 52 to a server 56 will be hereinafter referred to as a server transmission 78. The server transmission 78 comprises a graphical image of the document 20 that the user wishes to be transmitted via the document transmission system 50, which is hereinafter referred to as a human readable file 80, which may be a PDF file, JPEG file, GIF file, or any other suitable graphical representation. The server transmission 78 will also comprise a machine readable file 82, such as an XML file which represents, in machine readable format, the contents of the document 20. The user who transmits the document 20, is also able to optionally select any file that may be resident or accessible from the sending station 52, that may be transmitted along with the document 20 as an attachment 84. The server transmission 78 will be identified by means of an index 86, which is used to track the transmittal of a document 20, and is created every time a server transmission 78 is sent. The encryption/decryption module 70 causes the server transmission 78 to be transmitted between the sender station 52 and the server 56 in a manner wherein multiple levels of encryption are employed, as are described in further detail below.

Upon the server transmission 78 being received at a server 56, it is decrypted. The server 56 contains a directory database 88, which contains records of all users who have registered with the document transmission system 50. The server 56 proceeds to determine whether the document 20, that has been transmitted from a sender's station 52, is bound for a registered user of the document transmission system 50, by means of checking the directory database 88. If the document 20 is bound for a registered user of the system 50, the contents of the server transmission 78, specifically, the human readable file 80, the machine readable file 82, and any potential attachments 84 along with the index file 86, are transmitted to a recipient station in what is referred to as a recipient transmission 90, wherein multiple levels of encryption will be employed as is described in further detail below. If the server transmission 78 is not bound for a registered user of the system 50, the server 56 sends a message to the intended recipient informing them that a sender wishes to transmit a document 20 to them, and that they should register with the system 50, in order to be able to receive the transmission.

Upon the recipient transmission 90 being received at the recipient's station 52, it is decrypted. The recipient station 56 may have installed upon it, or accessible to it, an ERP (Enterprise Resource Planning) application 92. The ERP application 92 would then be able to access the machine readable file 80, through the use of specialized software (not shown) and extract appropriate data and transfer that data to the ERP application 92.

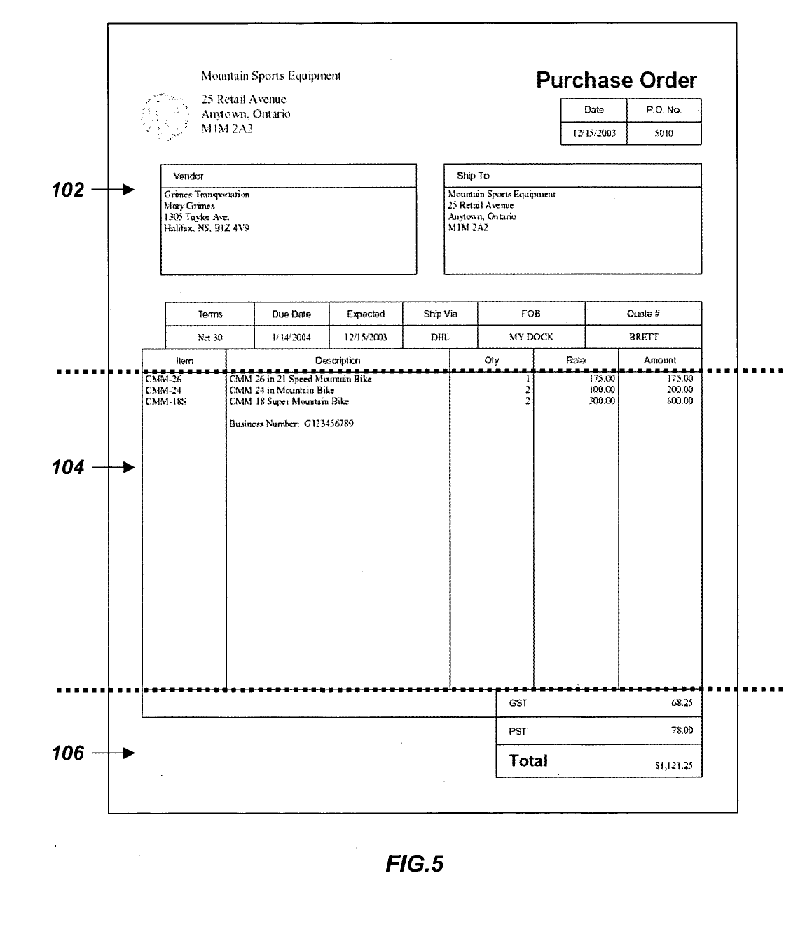

A detailed description of the operation of the document transmission system 50 is now described, with reference to an example of a type of document 20 that may be transmitted. Reference is now made to FIG. 5, where the general outline of a purchase order 100 is shown. Purchase orders 100 are used in business transactions and generally serve as a formal request from a purchaser to a vendor, for the purchase of goods and/or services. The document transmission system 50 of the present invention may be used to transmit documents of any type, however, for purposes of illustration, the purchase order 100 is used when describing the operation of the system 50.

The purchase order 100 shown in FIG. 5 is generally divided into three distinct areas, a header area 102, a body area 104, and a footer area 106. Each area, the header area 102, the body area 104, and the footer area 106 contains information with regards to the specifics of the transaction that is being conducted with the purchase order 100, or information that pertains to the parties involved (i.e. name, address, registration numbers, etc).

The header area 102 includes information regarding the parties involved in a transaction (i.e. the buyer, the seller) and information that is specific to the transaction at hand, such as the payment terms, the date the goods and/or services were ordered, and the date by which they are required. The header area 102 also includes an identifier, such as a purchase order number or invoice number, that is used as a means by which to track and differentiate purchase orders.

The body area 104 contains information regarding the specific details of the transaction. The body area 104 contains information pertaining to the description, cost and quantity of the goods and/or services that are being ordered.

The footer area 106 contains references to the monetary amounts that are involved in this transaction, including the total amounts inclusive of any taxes that are due.

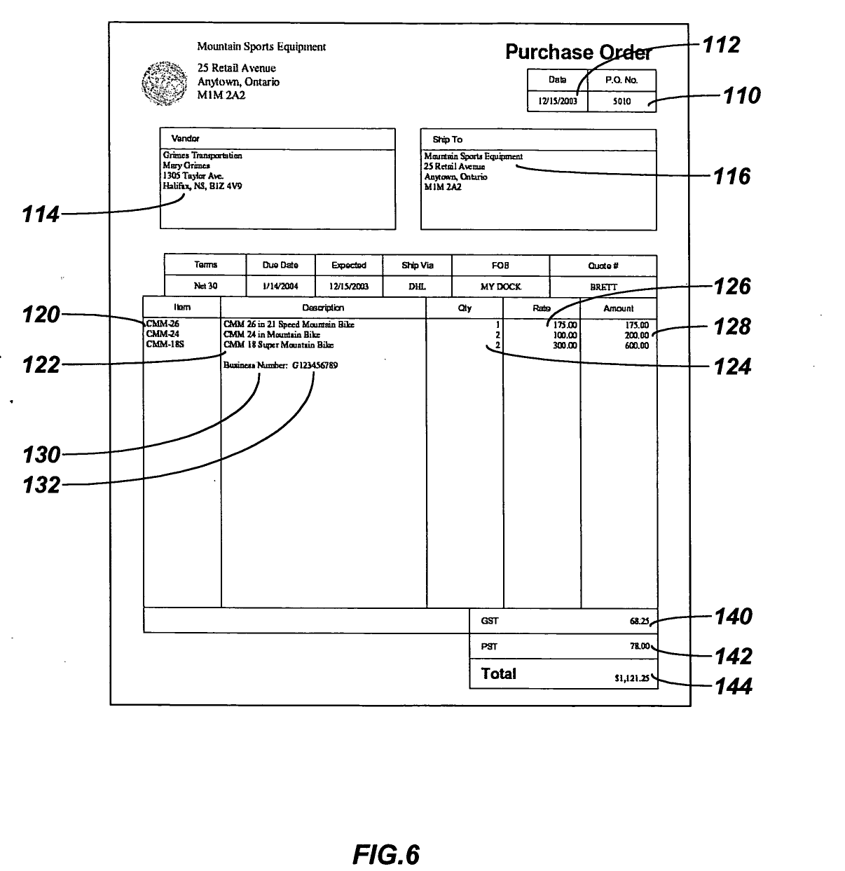

Reference is now made to FIG. 6, where the attributes that may be contained upon the purchase order 100 are described. Attributes refer to various headings under which information upon a document 20 may be found. The header area 102 is comprised of the following attributes; a purchase order number 110, a purchase order date 112, a vendor address 114, and a customer address 116. The body area 104 is generally comprised of the following attributes; an item number 120, a description 122, a quantity 124, a rate 126, an amount 128, a label identifier 130 and a label 132. The footer area 106 will generally be comprised of the following attributes; a first tax 140, a second tax 142 and a total price 144.

The document transmission system 50 is not limited to being used solely for the transmittal of purchase orders 100. The document transmission system 50 may be used to transmit documents 20 of any type, as long as they may have a document schema defined for them, using a standard such as XSD (XML schema definition). The application 54 contains various predefined XSDs (XML schema definitions) for each type of document 20 that the system 50 will allow transmission of. In this embodiment, as purchase orders 100 are being transmitted, an XSD has been created with respect to a purchase order. An XSD may be created for any type of document 20 that is to be transmitted. For example, an XSD may be created for request for quotations (RFQ), quotes, purchase orders, sales orders, packing lists, bill of ladings, freight bills and invoices. An XSD specifies how to formally describe the elements in a particular document in XML. The XSD provides the description of a document with respect to an XML format, and will therefore allow for the creation of machine readable files 82, which in this embodiment, are XML files. XML files, which are created and described in further detail below, will allow for the interchange of data, such that a software application is able to extract data from a XML file and then appropriately employ this data for use in a required application. The XSD that has been defined for the various document types will have been defined with respect to the attributes that must be contained in a document 20, which are referred to as required attributes, and may also include optional attributes that may be included in document types. The XSD will also generally be specified such that attributes will either generally be expected to occur in a detail section (generally the body area), or upon a master section (in the example of the purchase order, this being the header and footer area).

The document transmission system 50, may be employed in order to transmit documents 20 of any type, as long as a user will be able to define an XSD for a document type.

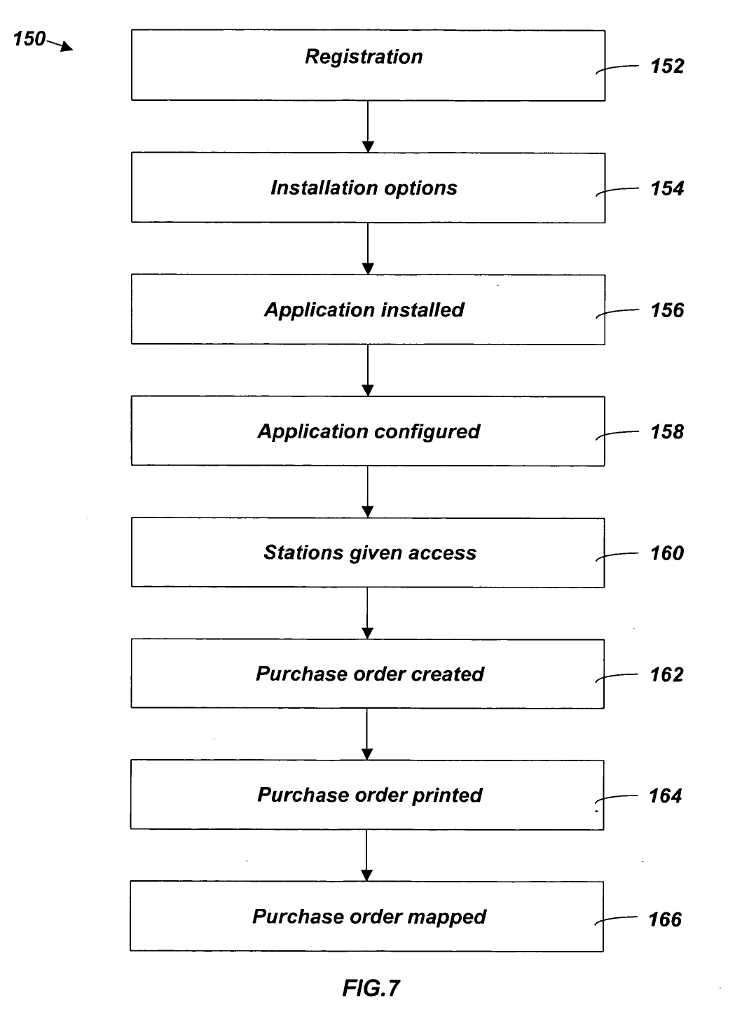

The process that a user will undertake in order to employ the document transmission system 50 to transmit documents 20 (for purposes of illustration a purchase order 100 will be used to describe the operation of the system) to another user of the system 50 for the first time will now be described with respect to method 150. Reference is made to FIG. 7, where the steps of method 150 are shown.

Method 150 begins at step 152 where a user registers with the system 50 through various means, among them including, a secure user registration service that is provided by the system 50. A user will be required to specify identification information (i.e. name of person or business), their contact information (i.e. address, phone number), billing information and any other information which may be required. A user is required to specify an e-mail address or other means by which data may be transmitted to them electronically, such as FTP. As is explained in greater detail below, a user of document transmission system 50 will receive documents 20 that are transmitted to them via e-mail or other electronic means, and thus it is imperative that they provide a valid e-mail address or other electronic means identifier by which electronic transmissions may be sent to them upon registration. A user may register with the system 50 under a variety of options, among them being that the user may only use the system 50 to be able to send documents 20, or to only be able to receive documents 20 or to be able to both send and receive documents 20.

In the present embodiment, the server 56, or any other associated apparatus, operates a website (not shown). The website includes a registration web page, which allows the user to register with the system 50. A user will also be able to register with the system 50 by means of electronic mail, telephone or mail. Information that is collected in these manners will then later be inputted into the server 56, in order to register a user.

Method 150 then proceeds to step 154 where the application 54 is installed, such that the stations 52 from which a user wishes to transmit documents 20 will be able to access the application 54. The installation module 60 of the application 54 allows for the application 54 to be installed such that it has what is referred to as either a closed or open configuration. Step 154 requires a determination of where exactly the application 54 is to be installed with reference to the stations within an enterprise/organization. Specifically, a station is chosen to act as an enterprise server. The enterprise server is the computing apparatus that allows for other stations to be connected to it, such that the application 54 that is to be installed may be accessed by other stations 52. The station that is chosen as an enterprise server should be one that has access to a communication network, such as the Internet, and which allows for other stations within an enterprise to access the directories, which are maintained on it.

Method 150 then proceeds to step 156, wherein the application 54 is installed on the enterprise server, by means of methods that are commonly known.

Method 150 then proceeds to step 158, wherein the application 54 is configured. In the preferred embodiment, two types of configurations are possible, an open configuration and a closed configuration.

An open configuration allows all network users who have access to the enterprise server to be able to use the document transmission system 50. Open configurations will generally be appropriate where security is not of the greatest concern within an enterprise/organization.

A closed configuration will require network users who have access to the enterprise server to be granted permission to use the document transmission system 50. A closed configuration provides increased security and control, with respect to who is able to access the system 50.

Method 150 then proceeds to step 160, wherein all stations within an enterprise who are to be given access to the station 52 that is functioning as the enterprise server are configured, so that they are able to act as a “client”, and can make use of the document transmission system 50.

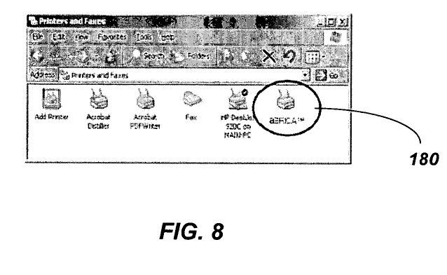

Upon the application 54 being installed such that the selected stations 52 within an enterprise have access to the application 54, the installation of the application 54 will result in what appears as an additional printer being added to the list of printers a station may print to. Reference is made to FIG. 8, where the additional printer that is made available to a user of a station 52, which has access to the application 54, is shown as mapper printer 180.

Method 150 then proceeds to step 162. In step 162, the user creates the specific purchase order 100 they wish to transmit through the document transmission system 50. A user creates the purchase order 100 by employing standard purchase order creation software that they would make general use of. For example, software applications such as SAP, JD Edwards, Peoplesoft and Oracle may be used.

Method 150 then proceeds to step 164. In step 164, after a purchase order 100, has been created, a user will be required to invoke the application 54. The application is invoked by means of attempting to print the purchase order 100 that has been created to the application printer 180. Upon the application printer 180 being printed to, method 150 will proceed to step 166.

Step 166 requires the user to specify the physical locations upon the purchase order wherein attributes may be located, and this is hereinafter referred to as mapping the document. Step 166 will further be described with reference to mapping method 200.

The mapping method 200 serves to capture the physical locations of the various attributes upon a particular document. The mapping method 200 will require the user to specify the locations, upon the purchase order 100, of the required attributes and the optional attributes. The mapping method 200 is undertaken by a user each time they are transmitting a specific document type (i.e. purchase order) from a specific software application for the first time.

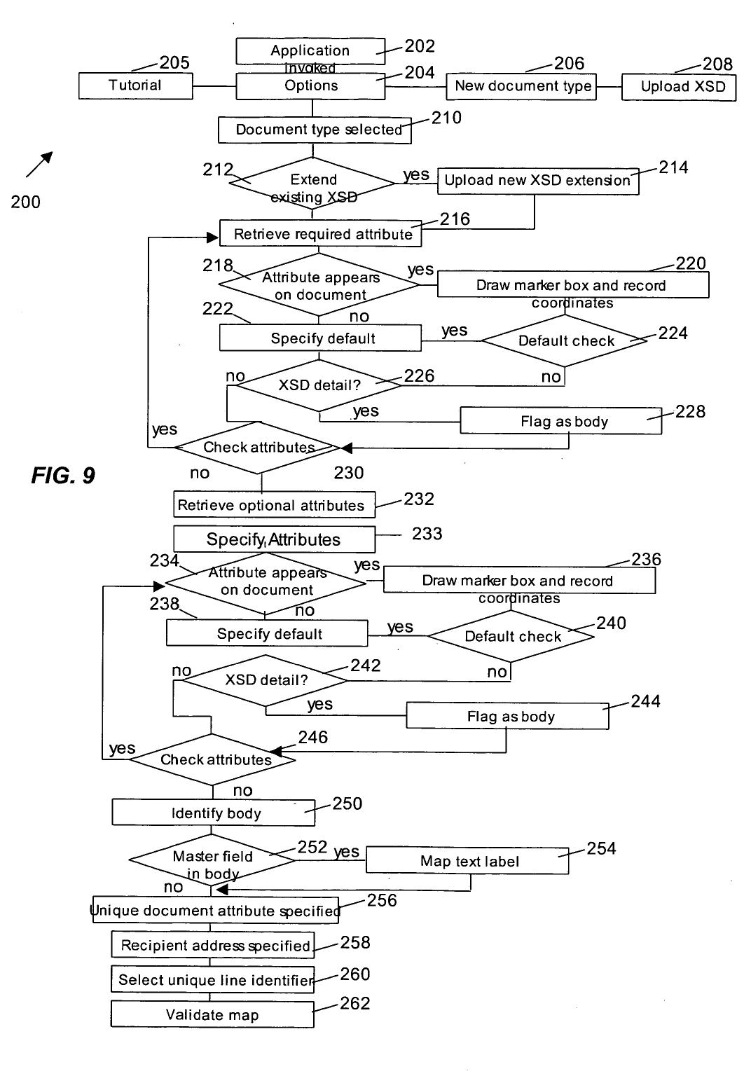

Reference is now made to FIG. 9, where the steps of the mapping method 200 in one embodiment of the invention are described in further detail. The mapping method 200 is employed in order to capture the physical locations upon a document wherein the attributes are found. The mapping method 200 will be described by way of example with respect to the mapping of a purchase order 100.

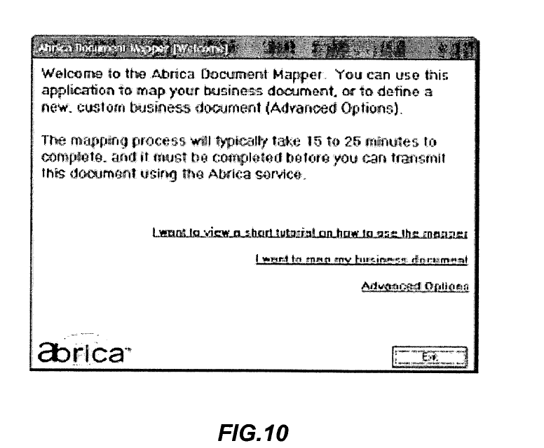

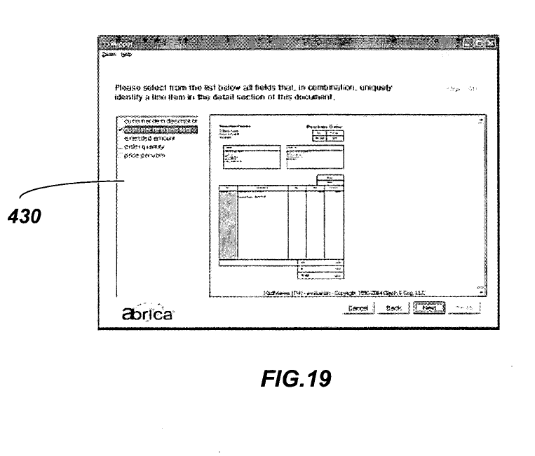

The mapping method 200 is further described with reference to FIG. 10-20, which further illustrate the steps that a user is to undertake, with respect to the mapping method 200.

Method 200 begins in step 202, where a user who has created the purchase order 100 wishes to use the document transmission system 50 for the first time, by invoking the application 54. The application 54, after it has been installed, is invoked by means of attempting to perform a typical print function of the purchase order 100. When the application 54 has been installed, additional printers will appear from among the ones a user may chose when printing from a station 52. The list of printers will include a mapper printer 180, as was shown in FIG. 8. The user will then be required to select the mapper printer 180 as the printer they wish to print the purchase order 100 to. Upon the user attempting to print a document 20 to the application printer 180, the data stream that is representative of this document 20 will be sent to the application 54.

Method 200 then proceeds to step 204, where as shown in FIG. 10, the user is presented with options with respect to a course of action they are to chose from. In the preferred embodiment, the user is provided with the option of viewing a tutorial on how to perform a mapping of the document, or to proceed to map the document, or to chose further advanced options where a new XSD for a document 20 may be defined.

Method 200 may proceed to step 205, 206 or 207 depending upon the user selection that is made in step 204. Step 205 of method 200 provides a tutorial to a user on the process that is undertaken with respect to mapping a particular document. Upon the conclusion of this tutorial, the method 200 will return to step 204.

Step 207 of method 200 provides to the user advanced options by which they may define a customized document that they wish to transmit to an intended recipient party. The user may upload an XSD that has been specified in step 208. Upon the conclusion of step 207, the method 200 will return to step 204.

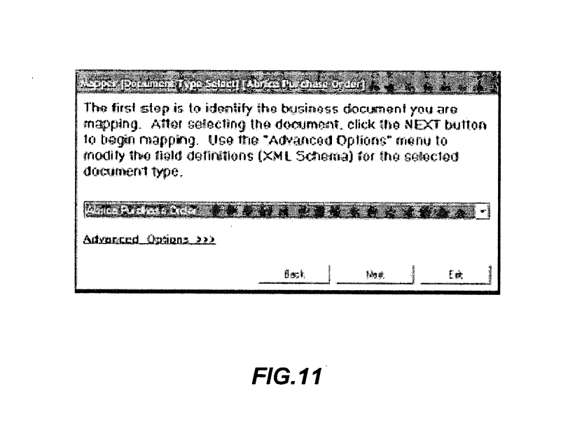

When method 200 proceeds to step 210, as shown in FIG. 11, a user is presented with options of selecting the type of document 20 they wish to transmit, or to modify the XSDs that have been defined for the various document types. The list of options with respect to the types of documents that are presented to a user in step 210 will depend on the XSDs that have been predefined and included as part of the application 54, or that have been defined and uploaded by a user as shown in step 207. In the preferred embodiment, as XSDs have been defined for purchase orders, a purchase order will be one of the options that is presented to a user. Method 200 then proceeds to step 212, where a user is presented with an option of extending an XSD. Extending an XSD refers to the functionality within XSDs that allows another XSD document to be combined with a preexisting one, when provision for doing so has been made in the XSD. If the user chooses in step 212 to extend an existing XSD, then method 200 proceeds to step 214 wherein the user will upload the new XSD extension. Upon the conclusion of step 214, and if the user chooses to not extend an existing XSD in step 212, then method 200 proceeds to step 216.

Method 200 then proceeds to step 216 wherein the required attributes as defined in the XSD for the particular document that is being mapped are retrieved. The required attributes within an XSD are those attributes which have been defined in the XSD such that they must occur at least once upon a document.

Method 200 then proceeds to step 218 wherein for each of the required attributes, the user is asked whether the attribute is found upon the document. If the attribute is found upon the document, then method 200 proceeds to step 220.

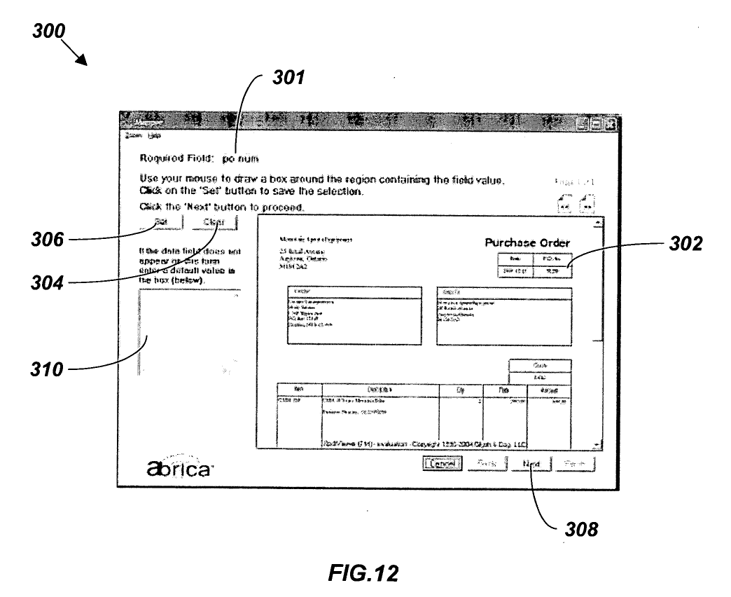

As shown in FIG. 12, in step 220 the purchase order 100 that was created is loaded into a view window 300. The user will be required to specify the location upon the purchase order 100 where the required and optional attributes appear. The user will be instructed to specify the location upon the purchase order where the attribute that is described in a required field box 301 is found.

With reference to FIG. 12, the attribute described in the required field box 301 is the purchase order number 110. The user will view the purchase order 100 through the view window 300, and draw a marker box 302 around the location on the purchase order 100 where the attribute is found. The user is able to draw a marker box 302 around the location of the attribute by employing the functionality of the mouse, as is commonly understood.

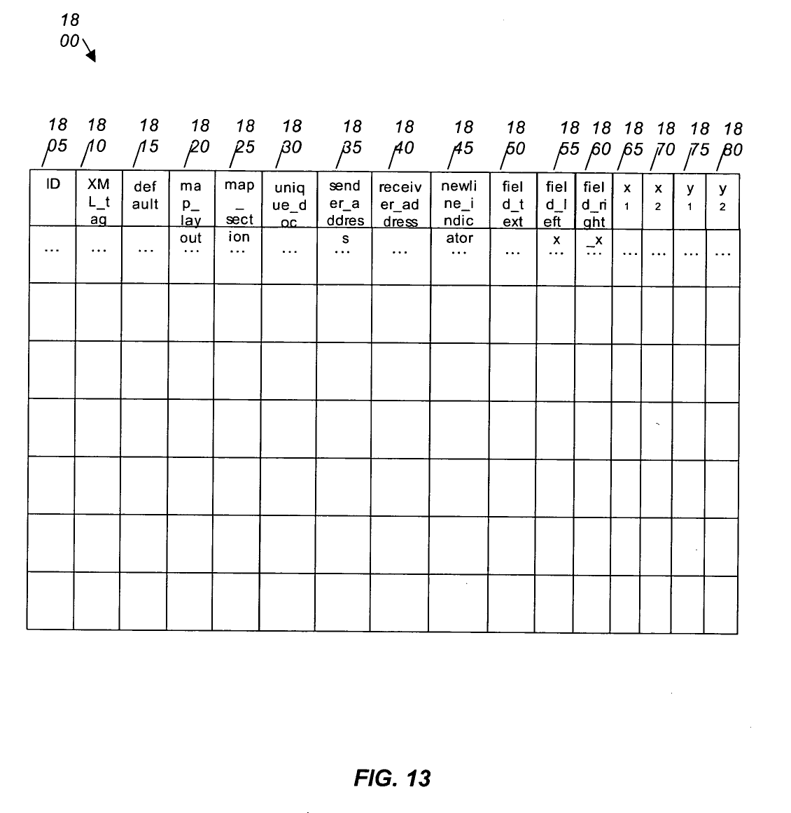

Once the user has drawn a box, and identified the location of the attribute upon a document, if the user wishes to draw another marker box 302 so that the attribute may be more accurately captured, the user may do so by activating a clear button 304 and then proceeding to draw another marker box 302. Once the user has determined that the marker box 302 has captured the correct physical location upon the purchase order 100 where the desired attribute is located, a set button 306 is then activated, which will save the location around which the user has drawn the marker box 302. In order to proceed to the next step, the user will then activate a next button 308. The co-ordinates of the marker box 302 that has been drawn are recorded in a document field map 1800 which is further illustrated in FIG. 13

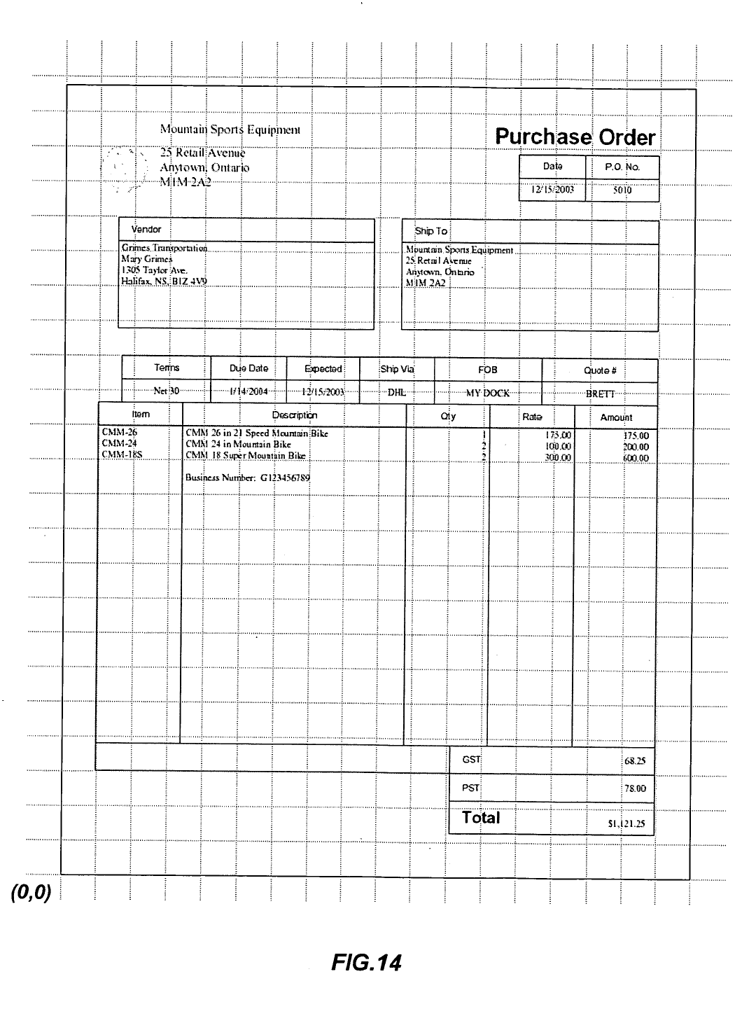

Reference is now made to FIG. 13 wherein the document field map 1800 and its associated fields are shown. The document field map 1800 in the preferred embodiment will contain an ID field 1805, an XML_Tag field 1810, a Default field 1815, a map_layout field 1820, a map_section field 1825, a unique_doc field 1830, a sender_address field 1835, a receiver_address field 1840, a newline_indicator field 1845, a field_text field 1850, a field_x field 1855, a field_y field 1860, an x₁ field 1865, an x₂ field 1870, a y₁ field 1875 and a y₂ field 1880. The XML_tag field 1810 will contain the XML tag name specified in the XSD for this data element. The default field 1815 will contain a default value that is to be assigned to a particular attribute as is explained in further detail below. The map_layout field 1820 will contain information with regards to what type of document is being mapped (for example, typical master-detail documents based on a “pre-printed form” metaphor). The unique_doc field 1830 contains an indicator (true or false) which specifies whether this attribute is the one that is used to delineate different documents. The sender_address field 1835 contains an indicator (true or false) that specifies whether the attribute is the sender's respective address. The receiver_address field 1840 contains an indicator (true or false) specifying whether the attribute represents the recipient's address. The newline_indicator field 1845 contains an indicator (true or false) that specifies whether the attribute can be used to determine a new line of data (generally within the body of a document). The field_text field 1850 is used for attributes which be may be located upon varied areas upon a document 20, and the field_x 1855 and field_y 1860 fields respectively, are used to record the respective x and y co-ordinates at which the attribute is located at in this instance of the document. The x₁ field, 1865, x₂ field 1870, y₁ field 1875 and y₂ field 1880, are used to record the x and y co-ordinates of the opposite corners, in which the marker box 320 has been drawn. The fields that have been made mention of will further be explained with reference to the following steps of method 200. Reference is made to FIG. 14, wherein a grid overlaid upon a purchase order 100 is shown, which illustrates how the co-ordinates may be specified. A document field map 1800 is created each time a document type is mapped, and will be stored such that it may be accessed for user on in the parsing functions that are part of the application 54.

Upon the user drawing a marker box and the co-ordinates of such marker box 320 being recorded in step 220, method 200 proceeds to step 224, wherein the user is asked to determine whether the attribute which has been mapped in step 220 may ever employ default value (i.e an example of this is when no currency indicator is provided, and it may be assumed that the terms of the currency are specific to a jurisdiction, such as Canadian dollars or U.S. dollars). If the attribute may use a default value then method 200 proceeds to step 222 wherein the user will enter the default value as shown in FIG. 12 in a default value field 310. Method 200 will also proceed to step 222 after it has been determined in step 218 that an attribute is not found upon a document. As shown in FIG. 12, a default value field 310 is provided for, for use when an attribute is not located upon a document. When an attribute is not located upon a document, or when an attribute may at times take on a default value, the user is able to enter into the default value field 310 a default value, which will be used by the document transmission system 50 when transmitting the document 20. The default value that is entered by the user will be stored in the default value field 1815 of the document field map 1800.

Method 200 proceeds to step 226 after the completion of step 222, or after it has been determined in step 224 that an attribute will not take on a default value. In step 226, it is determined whether the attribute that has been mapped or has had a default value specified, occurs in the body section of the document. If the attribute does occur in the body section of the document, then the attribute is flagged as being part of the body in step 228.

Method 200 then proceeds to step 230 wherein a check is performed to determine whether there remain, more required attributes that are to be mapped, or have default values specified for them. If further required attributes remain, then method 200 will proceed to return to step 216. If all the required attributes have been appropriately processed, then method 200 proceeds to step 232.

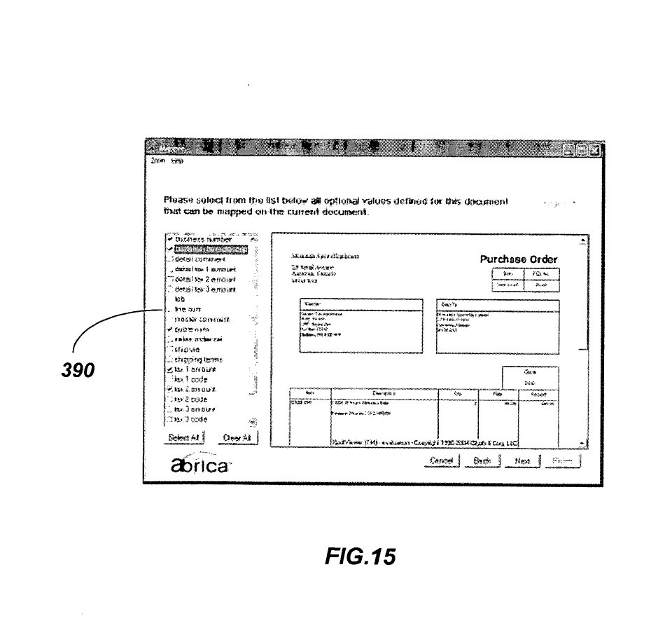

In step 232, method 200 retrieves all the optional attributes that are defined in the XSD. Optional attributes are defined within an XSD as those attributes which do not need to occur on a document. Method 200, then proceeds to step 233, wherein, as shown in FIG. 15, a user will be shown a list of all the optional attributes that may generally be found on a document 20, and in this example on a purchase order 100, in an options window 390. The user, in step 233, will proceed to specify the optional attributes that they wish to provide a mapping for with respect to the particular document type. Once the optional attributes have been specified in step 215, method 200 will proceed to step 234.

Step 234 will present to the user, a query with respect to whether an optional attribute is found on the document 20. If the optional attribute does appear on the document 20, as indicated by a user response, then method 200 proceeds to step 236 wherein as described in FIG. 12, a user will draw a marker box 302 around the attribute. Upon a user drawing a marker box 302 around the attribute, and the user activating the next button 308, the co-ordinates of the marker box 302 are recorded in a document field map 1800.

After the user has specified the location for the attribute in step 236, method 200 proceeds to step 240 wherein the user is asked to specify whether or not the attribute ever takes on a default value. If the attribute does take on a default value, as determined by the user response, then method 200 proceeds to step 238 wherein a default value is specified. Method 200 also proceeds to step 238 upon the determination in step 234 that an attribute can not be located upon a document. The user will specify a default value for the attribute of interest, and it will be recorded in the default value field 1815 of the document field map 1800.

Upon the conclusion of step 238 or upon the determination in step 240 that an attribute will not take on a default value, method 200 proceeds to step 242. In step 242, it is determined whether the attribute of interest is found in the detail section of the document 20. If the result of the query in step 242 is affirmative, then method 200 proceeds to step 244, wherein the attribute is flagged as being party of the body.

Method 200 then proceeds to step 246 wherein a check is performed to determine whether all of the optional attributes that the user has specified in step 233 have been mapped or have had a default value assigned. If all the optional attributes have been mapped, or have had a default value assigned, method 200 will proceed to step 250. If optional attributes remain to be mapped, then method 200 will return to step 234.

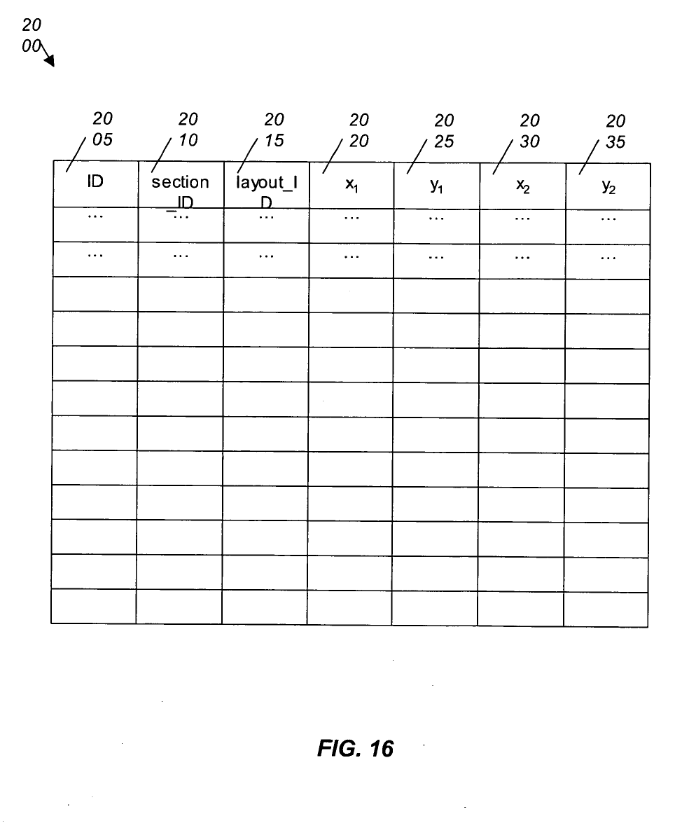

Step 250 will present to the user an image of a document 20 which has its body areas highlighted. The body area is determined by the method based on the attributes that were flagged as being part of the body in steps 228 and 244, respectively. The user is asked to confirm that the area that is displayed does represent the body of the document 20. Method 200 has based the determination of the body area upon a document by employing logic as part of the application 54. For example, the checks which are done in steps 226 and 242 determine whether the mapped attribute appears in the “detail” section of the XSD. As mentioned above, an XSD will have a detail section and a master section. If the attribute does occur within the detail section, then the top right corner and bottom left corner of the marker box are used to define the body section. These co-ordinates are updated based on subsequent attributes being flagged as being part of the body. However, as some attributes may be found in the detail section and not be part of the body, as a result a check is done to determine whether the height of the marker box is equal to at least half the height of the body co-ordinates. If the height of the marker box is not equal to at least half of the height of the body co-ordinates, then the attribute will not be shown as being part of the body. Alternatively, it is not required that the method 200 keep track of what will be the body area, rather the user may be asked to specify if the location upon a document wherein the body of the document may be found. Reference is made to FIG. 16 wherein a document section map 2000 is shown. The document section map 2000 contains an ID field 2005, a section_ID field 2010, a layout_ID field 2015, an x₁ field 2020, a y₁ field 2025, an x₂ field 2030 and a y₂ field 2035. The co-ordinates of the body will be stored in the respective x and y fields.

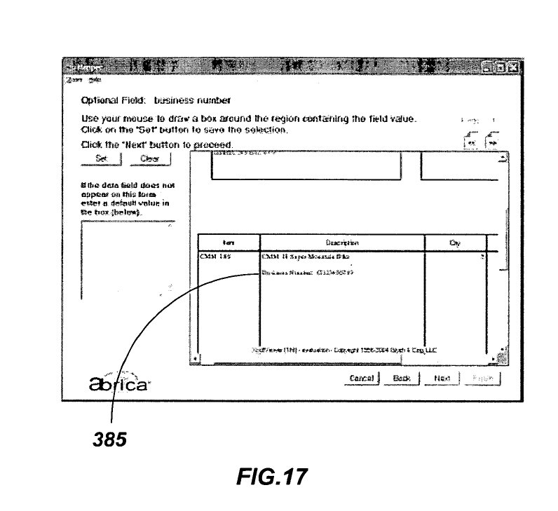

Method 200 then proceeds to step 252. In step 252, it is determined whether an attribute that belongs in the master section of a document appears in the body field. . . For example, reference is made to FIG. 17, wherein it is shown that the business number appears in the body section of a document.

Based upon the determination in step 252, method 200 then proceeds to step 254, wherein the attribute that occurs within the body area is mapped. Reference is made to FIG. 17, where the user will draw a marker box around the label that is used to identify the attribute of interest, as is shown in FIG. 17. A label is used to identify an attribute where the attribute may generally be found at various locations upon the document 20. For example, FIG. 17 shows that a user has drawn a marker box 385 around the label that is used to designate the business number. For attributes that are mapped in step 254, via a marker box 385 being drawn around their label, an entry is made with the label, used to identify the attribute, which in this example is the “business number” and that label is entered in the field_text field 1850, along with the left and right x co-ordinates which are stored in the field_left_x and field_right_x fields 1855 and 1860, respectively.

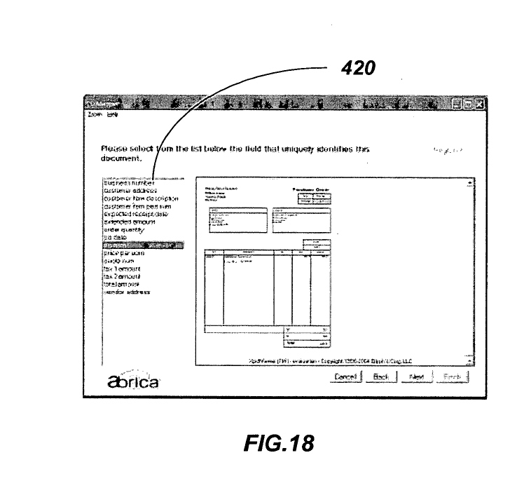

Method 200 then proceeds to step 256. Step 256 presents to the user a list of all the mapped attributes, as shown in FIG. 18, in a unique identifier window 420. The user must highlight the attribute among the ones shown in a unique identifier window 420, that can be used to differentiate between documents 20. For example, with respect to a purchase order 100, each different purchase order 100 will have a unique purchase order number 110. The unique identifier that is chosen by the user in step 256 will be used by the system, as is explained in further detail below, with respect to the transmission of documents via the document transmission system 50. Once the user has specified the attribute that may act as a unique identifier, the document field map 1800 has its unique_doc field 1830 populated. The unique_doc field 1830 is populated by having the entry that corresponds to the attribute that user has specified in step 256 as being set to true, and all others set to false. Upon the user having specified the unique identifier that was asked for, method 200 will proceed to step 258.

Method 200 then proceeds to step 258, where the user is required to choose the attributes that will serve as the recipient address and sender addresses, respectively. Upon the user selecting the attribute that represents the receiver's address, the entry in the receiver_address field 1840 in the document field map 1800 for the corresponding attribute is set to true, and the other entries within the receiver_address field 1840 are set to false. Also, upon the user selecting the attribute which represents the sender, the entry in the sender_address field 1835 in the document field map 1800 for the attribute that has been specified is set to true, while all other entries are set to false within the sender_address field 1835.

Method 200 then proceeds to step 260, a shown in FIG. 18, where the user is required to chose the attributes that may serve as line identifiers from the list presented in the line identifiers window 430. The line identifiers options window 430 will contain a list of all the attributes which may be employed to determine when a new line of data within a document has begun. The user may select one or more attributes that are used to determine the presence of a new line of data. Upon the user selecting the attribute or attributes that are used to determine the presence of a new line, the newline_indicator field 1845 for those respective attributes is set to true, and false for the others.

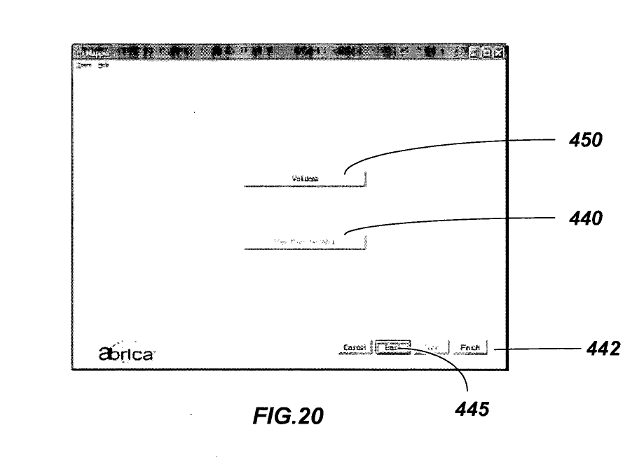

Method 200, upon the completion of step 260, then proceeds to step 262, wherein the map that has been created may be validated against the XSD defined for the document type by clicking on the Validate Map button 450. As shown in FIG. 20, the user will have the option, at step 230, to view in the preferred embodiment, an XML document that has been created based on the mapping that has been done. The user may view the XML document that has been created by clicking on the view XML button 440. The user is also able to go back and remap any of the attributes they had previously mapped by simply clicking on the back button 445. If the user wishes to accept the mapping, as has been completed up this point, they may do so by selecting a finish button 442.

Upon the conclusion of method 200, a document field map 1800, and a document section map 200 will have been created, which is used to create the various representations of a document. Also, a document specific printer will be created, which will be a printer that appears as one of the printers the user may print to. The document specific printer will be used after the user has undertaken a mapping of a document, and wishes to employ the document transmission system 50 with respect to the transmission of a document of a certain type for which a mapping has been completed.

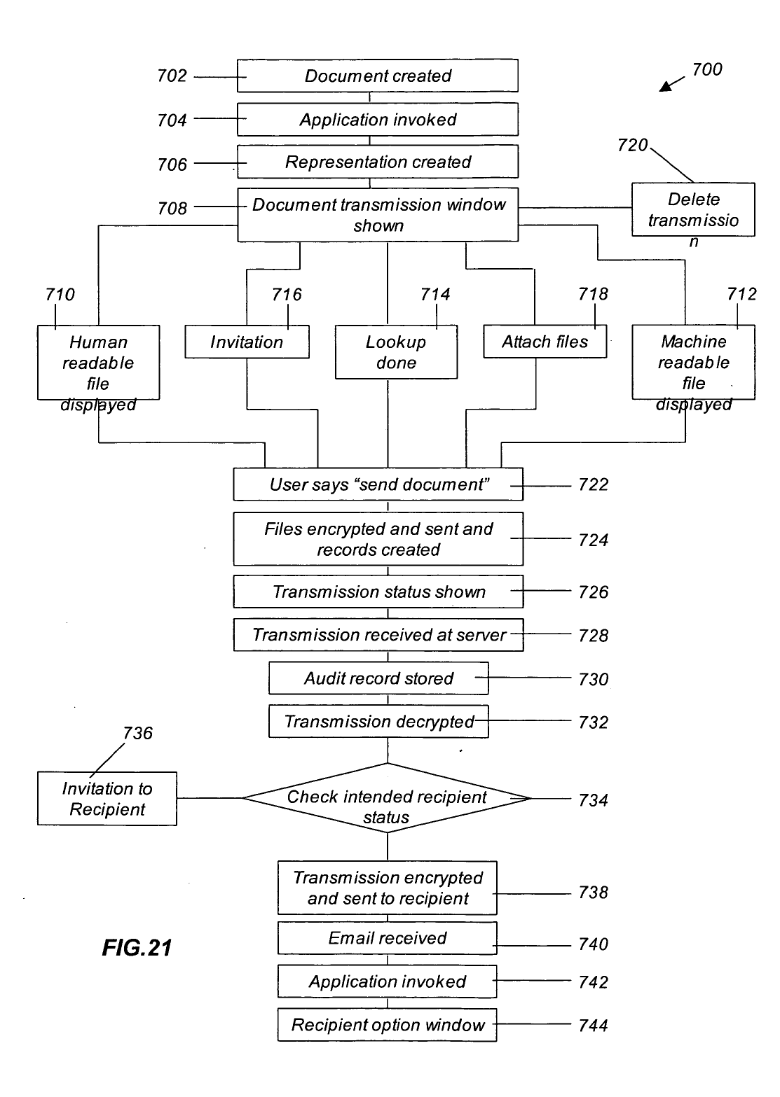

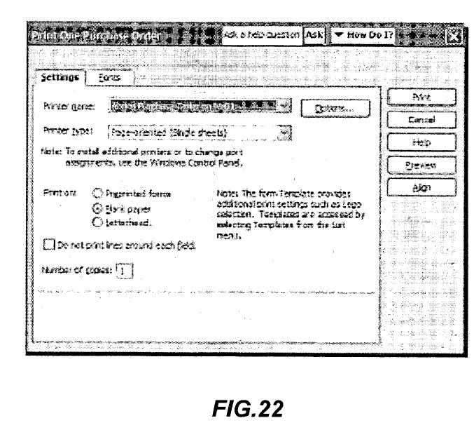

The operation of the document transmission system 50 is now described with reference to method 700. Method 700 describes the operation of the document transmission system 50 with respect to the transmittal of a document 20 after the requisite steps of method 150 have been completed. Reference is made to FIG. 21, wherein the steps of method 700 are shown. Method 700 will further be described with reference to FIG.22 to 29.

Method 700 begins at step 702 where a user creates the document 20 that they wish to transmit. Method 700, for purposes of illustration, will be described with reference to the transmission of a purchase order 100. In step 702, the purchase order 100 may be created through the use of any software that is suitable.

Method 700 then proceeds to step 704, where the user proceeds to invoke the application 54, in order to transmit the purchase order 100. A user invokes the application 54 by means of performing a typical print function. Specifically, the user will print the purchase order 100 to the application printer 180. Reference is made to FIG. 22, where a sample screen, that may be seen by a user who attempts to print their purchase order 100 to the document specific printer, is shown.

Method 700 then proceeds to step 706, where the parser module 70 receives the purchase order 100 that the user is attempting to transmit, and will create the appropriate representations of the documents that will be transmitted, namely a human readable file 80 and machine readable file 82. The method by which these respective documents are created is described in further detail below with respect to method 1000. The subscriber ID (stored in local database 76) associated with the recipient address information that is found on the document is sent to the server 56 as well, such that the server 56 is able to perform a lookup based on the subscriber ID to determine the e-mail address that the various representations along with any optional attachments are to be sent.

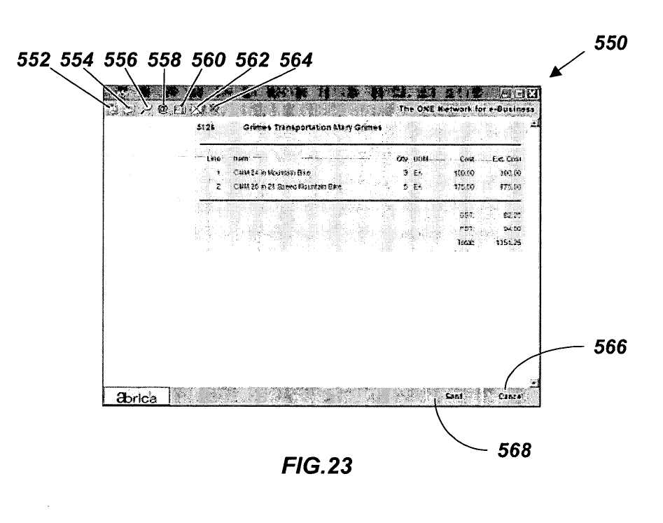

Method 700 then proceeds to step 708, where a document transmittal window 550, as shown in FIG. 23, is created and displayed to the user. The document transmission window 550 displays the contents of the purchase order 100. The document transmission window 550 includes icons that provide the user with additional functionality, from which they can choose. Specifically, the document transmission window 550 displays a human readable icon 552, a machine readable icon 554, a lookup icon 556, a invitation icon 558, an attachment icon 560, an omit transmission icon 562, an omit partner icon 564, a cancel button 566, and a send button 568. Depending on the selection made by a user, method 700 will proceed to either step 710, 712, 714, 716, or 718.

Method 700 then proceeds to step 710 upon the user selecting the human readable icon 552. Upon selecting the user readable icon 552, the user will have the human readable file 80 displayed for them, which in the preferred embodiment, is the PDF of the purchase order 100. Similarly, method 700 proceeds to step 712 when the machine readable icon 554 is selected, and the user has the machine readable file 82, which in the preferred embodiment, is an XML file that is representative of the purchase order 100, displayed to them.

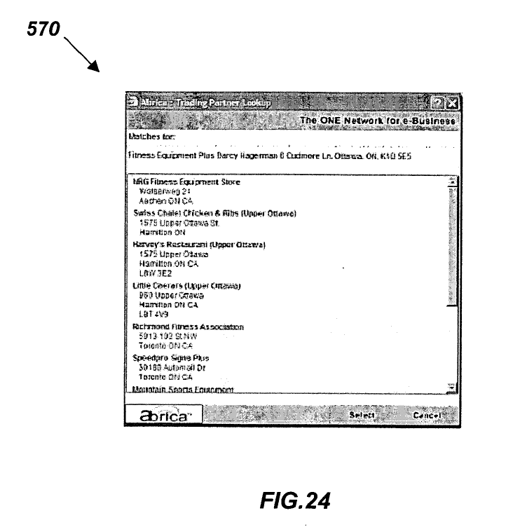

Method 700 proceeds to step 714 when the lookup icon 556 is selected by the user, and this selection allows the user to determine whether the intended recipient of the purchase order 100 is a registered user of the system 50. Upon the lookup icon 556 being selected by the user, the database directory 88 is searched to determine whether any registered users of the system 50 match with the intended recipient of the document 20. Reference is made to FIG. 24, where upon the lookup icon 556 being selected the search results of the directory database 88 having been searched are displayed in a lookup results window 570. The search of the directory database will display to the user results which partially match the recipient information that had been entered on the purchase order 100 in the vendor field. The search results which are displayed are the result of a broad based search, such as a full-text “fuzzy search”.

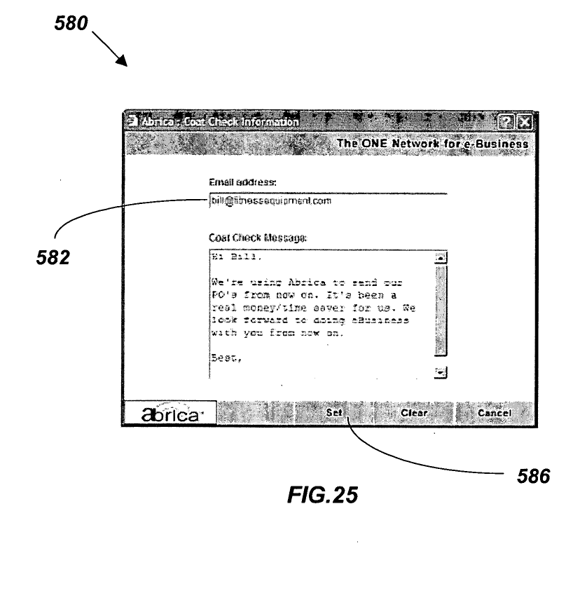

Method 700 then proceeds to step 716 upon the user having selected the invitation icon 558. Upon the user selecting the invitation icon 558, an invitation 580, as shown in FIG. 25, is displayed to the user. The user will be able to have the invitation transmitted to the intended recipient via e-mail by entering the intended recipient's e-mail address in an address field 582. The user is also able to optionally write a message that will accompany the invitation 580, in a message field 584. When the user wishes to send the invitation, the user may do so by means of selecting the set function button 586. Upon the user wishing to send the invitation, the invitation is transmitted as an e-mail message to the intended recipient, as is described in further detail below.

Method 700 then proceeds to step 718, upon the user having selected the attachment icon 560. When the attachment icon 560 is selected, this allows a user to add a file to be attached, that will be sent to the intended recipient along with the various representations of the document 20, that have been created in step 706.

Method 700 then proceeds to step 720 upon the selection of the omit transmission icon 562, which results in the particular purchase order 100 not being transmitted. The omit partner icon 564, when selected, will mean that no further purchase orders 100 will be transmitted to this particular intended recipient. If this option is selected, any further transmissions which are bound for this recipient will not be sent.

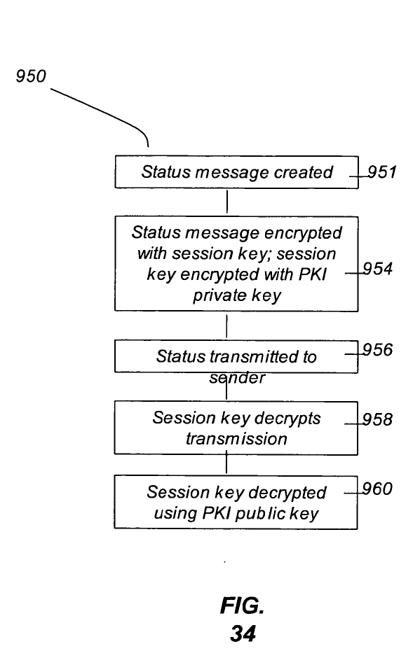

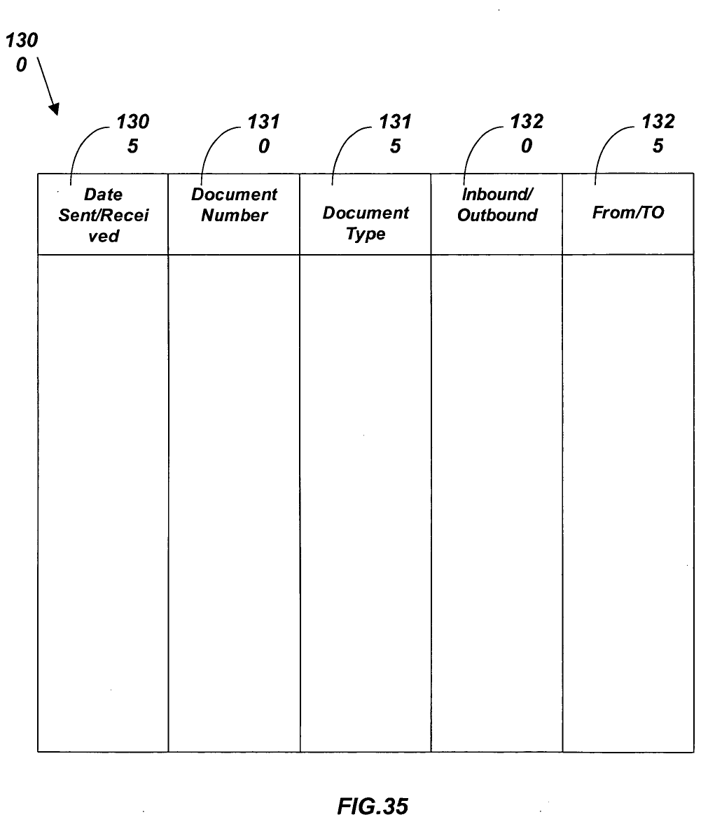

When the user is prepared to send the purchase order 100 to the intended recipient, they will do so by means of selecting the send button 568, and method 700 will proceed to step 722. Upon the user selecting to send the transmission by means of selecting the send button 568, method 700 will proceed to step 724, wherein the transmission is encrypted, as will be described in method 900 below, and is sent to the server 56 by means of a communication network 58. Also, a record with respect to the transmittal is created at this point, however, it not entered into a transmission database as shown in FIG. 35, until a status message is received from the server 56. The status message that is received from the server is discussed in greater detail with respect to FIG. 34.

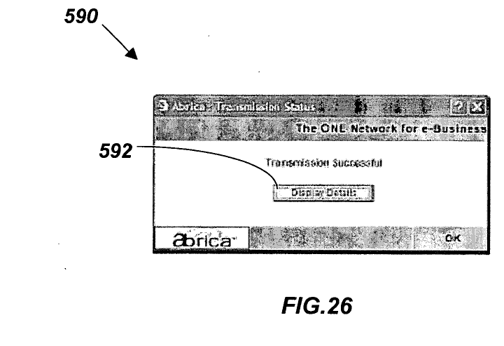

Also, upon the user selecting the send button 568, a transmission status window 590, as is shown in FIG. 26, is displayed to the user. The transmission status window 590 will comprise a display details button 592. Upon selecting the display details button 592, a transmission status details window is displayed to the user. The transmission status details window provides a report indicating how many documents were sent by the user, how many invitations were sent by the user, how many documents were omitted by the user, and how many documents were omitted as invalid.

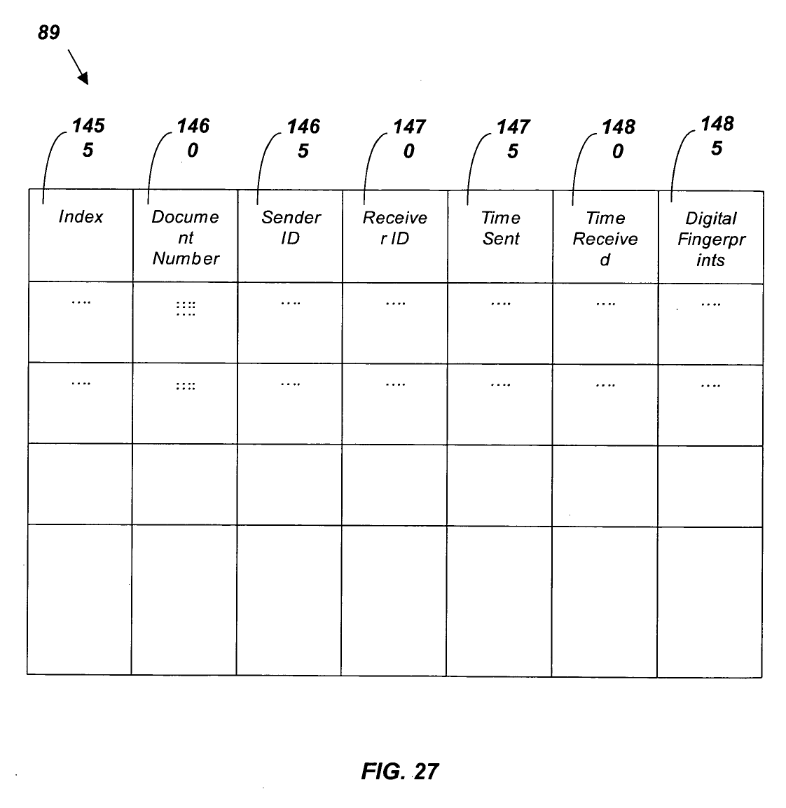

Method 700 then proceeds to step 728, where the transmission is received at the server 56. Upon the transmission being received at the server 56, an audit record is stored at step 730 in the audit record database 89. Reference is made to FIG. 27, wherein some of the fields contained within the audit record database 89 in a preferred embodiment are shown. In a preferred embodiment, the audit record database 89 contains the following fields, an index field 1455, a document number field 1460, a sender field 1465, a receiver ID field 1470, a time sent field 1475, a time received field 1480, and a digital fingerprints field 1485. Upon the document being received at the server 56, all fields, except the time sent field 1475, will be populated. The time send field 1475 will be populated when the transmission is sent to the intended recipient, as is described below. All records of time that are maintained by the document transmission system 50 are based on the time clock (not shown) that is maintained by the server 56. The digital fingerprints that are recorded in the digital fingerprints field 1485 are created by means of employing a hash function. In the preferred embodiment, an MD5 hash function is used to generate the digital fingerprints.

Method 700 then proceeds to step 732, where upon the transmission is decrypted. The specifics of encryption and decryption are described in method 900, which is described in further detail below.

Method 700 then proceeds to step 734, where the system 50 will determine whether the intended recipient of the transmission is a registered user of the system 50. This determination is performed by means of a lookup of the database directory 88. If it is determined that the intended recipient is not a registered user of the system 50, then method 700 will proceed to step 736 where the intended recipient will be sent an invitation to join as the sending party will have provided an e-mail address to which the invitation will be sent.

Method 700 then proceeds to step 738, if it is determined in step 734 that the intended recipient is a registered user of the system 50, wherein the transmission is encrypted and sent to the intended recipient. The transmission is sent to the recipient, in the preferred embodiment, as an e-mail message which contains attachments, which are representative of the various representations of the document 20 that have been created.

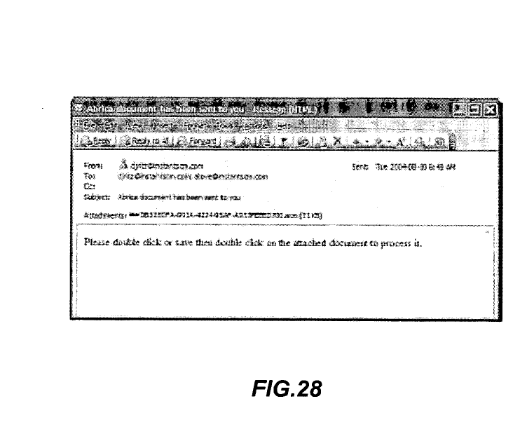

Method 700 then proceeds to step 740, wherein the transmission is received by the intended recipient as an email attachment, as is shown in FIG. 28. An e-mail message is employed in the preferred embodiment as the means by which the server will transmit data to the recipient, however, server 56 is not restricted to using e-mail, as various other electronic means may also be employed such as ftp or http post forward, or other such the TCP-IP address associated with a recipient or any other suitable transmission protocol (for example WAP, UDP). The e-mail will be from the sender, thereby ensuring that this is a recognizable e-mail address, and that the intended recipient will pay it due attention. The attachment that is sent will have a specific extension that will be recognizable only to the application 54. Therefore, it will be required for a recipient to have installed the application 54, such that they may be able to process the e-mail attachments.

Method 700 then proceeds to step 742, where the user will click on the attachment, thus invoking the application 54. Upon the application 54 being invoked, the contents of the transmission will be decrypted as is described in method 900.

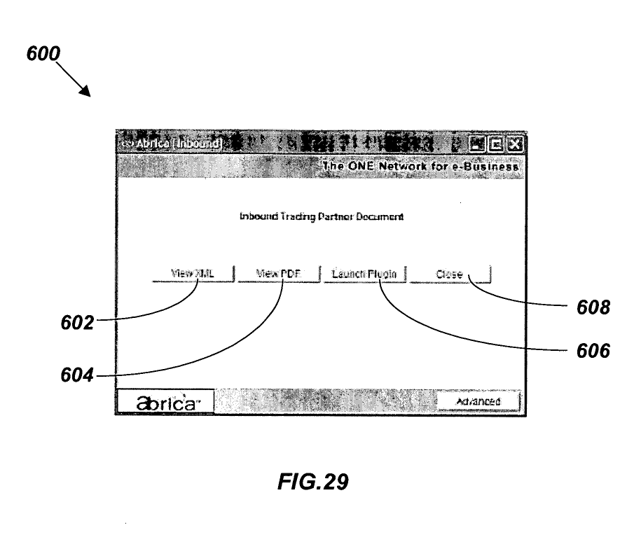

Method 700 then proceeds to step 744, where upon a recipient option window 600, as is shown in FIG. 29, is created, and shown to the user. The recipient option window 600 presents to the user various options. Specifically, the user will be able to select a view machine readable button 602, a view human readable button 604, a launch plugin button 606, and a close button 608.

The view machine readable button 602, when clicked on, causes the machine readable file 82 to be displayed to the user. The view human readable button 604, when clicked on, causes the human readable file 80 to be displayed to the user. The launch plug in button 606, when selected, will cause an optional ERP plug in application (not shown) to be executed. The ERP plug in application, if installed, would be able to access the XML file such that information (with respect to the attributes) in it can be uploaded into an ERP application that is being used by the user. This therefore, eliminates the need for any manual data entry to be performed. The close button 608 causes the recipient option window 610 to be closed.

The document transmission system 50 of the present invention makes use of an encryption method 900 which is used to ensure the secure delivery of documents 20 that are to be transmitted over communication networks 58, such as, for example, the Internet. The operation of the encryption method 900 is described with reference to the transmittal of a document 20 from a sender's station 52 to a recipient's station 52. Although the encryption method 900 is being described with reference to the transmittal of documents 20 between stations 52, which are typically personal computers, it should be understood that encryption method 900 may be used by any device or application. For example, a wireless communication device, cellular telephone, or any other apparatus that is capable of sending and/or receiving data via a communication network 58, may employ the encryption method 900.

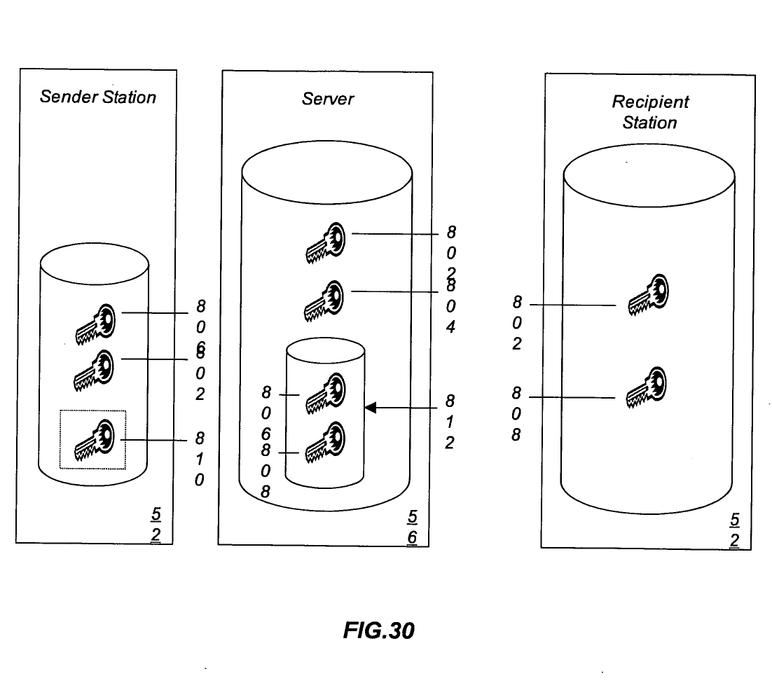

It should also be understood that encryption method 900 is not only to be used for the transmission of documents 20 that are created upon stations 52, but for data of any type that needs to be transmitted securely. Reference is now made to FIG. 30, where a block diagram detailing the keys that are made use of in the encryption method 900, with respect to a transmission between the sender station 52 the server 56 and the recipient station 52 are shown. As is commonly understood, encryption methods are employed by making use of elements referred to as keys. Upon registering with the system 50 and installing the application 54, a unique identification (ID) key, which will generally be a 128 bit symmetric key, will be generated. With reference to FIG. 30, it is shown that the sender will have a unique ID key 806 and the recipient will have a unique ID key 808. Each user who has registered with the system 50, will have an unique ID key that has been generated for it when the application 54 has been installed. In the preferred embodiment, the unique ID key will be a 128 bit key.

The server 56 will also have associated with it, a server public key 802 and a server private key 804, which form a private key/public key pair. The server public key 802, in the preferred embodiment, is a 1024 bit MD5 RSA PKI key. The server 56 has a digital certificate, which is issued by a recognized certificate authority such as Verisign or Thawte. The stations 52, which send and or receive encrypted communication to or from the server 56 do not require a certificate, thereby reducing the infrastructure that is needed for encryption method 900.

Data encrypted using a private key of a private key/public key pair can only be decrypted using the corresponding public key of the pair, and vice-versa. Private key information is not made public, whereas the public key information may be shared. For example, if a sender wishes to send a message to a recipient in encrypted form, the recipient's public key is used to encrypt a message, which can then be decrypted only using the recipient's private key. The server private key 804 is securely stored upon the server 56 in such a manner that it is accessible only to the server 56. The server public key 802 is accessible by all stations 52, and is stored upon stations 52 that are part of the document transmission system 50. The server public key 802 is provided to users as part of the application 54. Upon the unique ID key being generated, it will be encrypted with the server public key 802 and sent to the server 56. The unique ID key after it has been created, will be sent to a server 56 and the server 56 will keep a copy of the ID keys that it has received for each user within a secure ID key store 812.

Each time a document 20 is to be transmitted via the document transmission system 50, a one time session key 810, that will be used for the purposes of ensuring the secure transmittal of a document 20 from a sender to a recipient, is created. Session key 810 will generally be a 128 bit symmetric key.

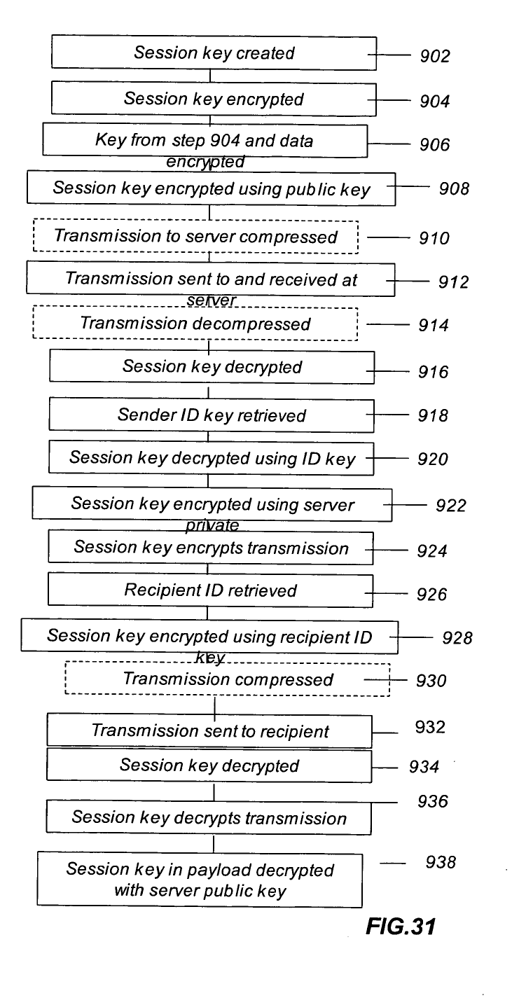

Reference is now made to FIG. 31, where a flowchart detailing an encryption method 900 which allows for more efficient encrypted transmittal of data between stations and or devices, is shown.

Method 900 will be described with respect to the transmittal of the representations of a document 20 that have been created, namely a human readable file 80 and a machine readable file 82. However, as stated above, method 900 may be used to ensure the secure and efficient transmittal of any data.

Method 900 starts with step 902, wherein a session key 810 will be created. Method 900 will then proceed to step 904, where upon the session key 810 that has been created is encrypted using the sender's ID key 806

Method 900 then proceeds to step 906, whereupon the representations of documents 20 that have been created, which as described above are a human readable file 80, and a machine readable file 82, along with any optional attachments 84 that may have been included along with the index key 86 and the already encrypted session key (performed in step 904), are all encrypted with the session key 810.

Method 900 will then proceed to step 908, whereupon the session key 810 will be encrypted with the server public key 802. The encrypted session key 810 of step 908, along with encrypted data of step 906 will comprise the server transmission 78. By having the session key 810 encrypted with the server public key 802, this ensures that only the server 56 will be able to decrypt the session key 810, as it contains the corresponding server private key 804. This eliminates the possibility that encrypted contents of the server transmission 78 may be viewed if the server transmission 78 is intercepted by any unauthorized party, as they will not have access to the server private key 804. The server transmission 78 will also comprise an attribute that specifies identity information that can be used by the server to identify the recipient.

The server transmission 78 will then be compressed, by employing known compression algorithms such as ZIP, in step 910. It should be noted that step 910 is an optional step with respect to method 900 and is undertaken to reduce the size of the data transmission that is undertaken. The session key 810 is retained by the sender, and is retained until a status message is received from the server 56 confirming the forwarding of the transmission to the intended recipient party as is described in further detail below.

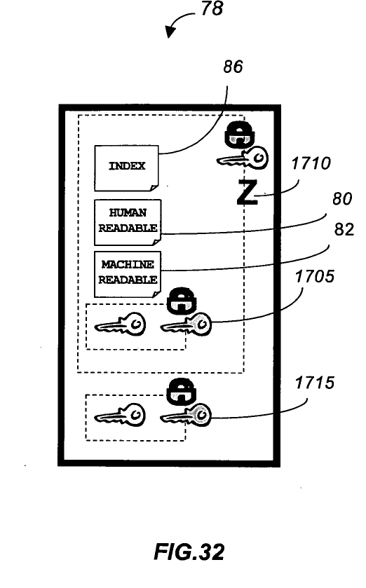

Reference is now made to FIG. 32, wherein the server transmission 78 and its contents are displayed in accordance with the steps undertaken at a sender's station 52 with respect to the encryption method 900. Reference is made to item 1705 of FIG. 32 wherein it is shown that the session key 810 has been encrypted by the senders ID key 806, as was described in step 904. Reference is made to item 1710, which shows the encryption of step 906. Reference is made to item 1715, which shows the encryption of step 908.

The encryption steps employed in step 906, as identified by item 1710 in FIG. 32, was undertaken by encrypting the data with the session key 810.

Method 900 will then proceed to step 912, whereupon the encrypted server transmission 78 is sent from a sender's station 52, via the communication network 58, to the server 56. The encrypted server transmission 78, in the preferred embodiment, is transmitted from a sender's station 52 using the HTTPS (Hyper Text Transfer Protocol Secure) protocol via a SSL (Secure socket layer). The HTTPS protocol is the standard encrypted communication protocol that is employed for communication via the internet. SSL is a security protocol that allows for private communication over the Internet. SSL allows for client server applications to communicate in a way that prevents interception, message tampering, or message forgery.

Upon the server transmission 78 being received at the server, if it has been compressed, method 900 undertakes to decompress it, at step 914. As mentioned above, the step of compression and subsequent decompression are optional steps, which may be undertaken in method 900.

Method 900 will then proceed to step 916 whereupon the steps required to decrypt the server transmission 78 at the server 56 are undertaken. Upon the encrypted server transmission 78 being received at the server 56, the session key 810 that has been encrypted in step 908 is decrypted by the server private key 804. As the session key 810 is encrypted in step 908 by the server public key 802, only the server private key 804 is then able to perform the required decryption. This requirement eliminates the possibility that the server transmission 78 is intercepted by an unauthorized party, as the server private key 804 will only be located upon the server 56 and thus the server transmission 78 will only be able to be received and processed at the server 56.

As a result of the decryption undertaken in step 916, the server 56 is now able to employ the session key 810 for further decryption/encryption that is required. From attributes passed as part of the content of the transmission, the identity of the sender is determined.

The sender ID key 806, which is stored in the secure data store 812, is then retrieved in step 918. As mentioned above, the server 56 keeps copies of the ID keys that have been created for each respective user of the system 50. Method 900 then proceeds to employ the retrieved sender ID key 806 to decrypt the session key in step 920. If step 920 is successful, it is thereby ensured that the sender has been authenticated.

Method 900 then proceeds to step 922, wherein the steps that are required to encrypt the transmission that is intended for the recipient are undertaken. In step 922, the session key 810 is encrypted using the server private key 804. Method 900 then proceeds to step 924, wherein the files and index, along with the encrypted session key from step 922 are encrypted by the session key 810.

Method 900 will then proceed to step 926, wherein the ID key that belongs to the recipient is retrieved from the ID key store 812 contained upon the server 56. Upon the recipient ID key 808 having been retrieved by the server 56, it is then used to encrypt the session key 810, in step 928.

Method 900 may then proceed to step 930, wherein the transmission that is sent to be the recipient's station 52 is then compressed.

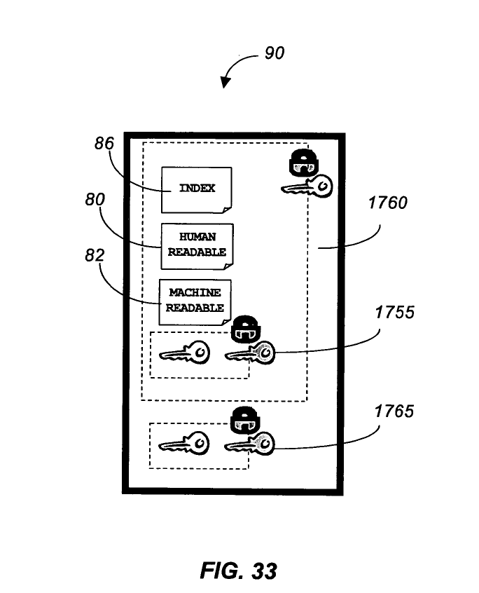

Reference is made to FIG. 33, wherein the various encryption steps that have been described as taking place at the server 56 are referenced. Reference item 1755 on FIG. 33 shows that the session key 810 has been encrypted by the server private key 804. Reference item 1760 shows how the various files, which include the human readable file 80, the machine readable file 82 and the index, along with the encrypted session key 810, are then encrypted with the session key 810. Reference item 1765 shows how the session key 810 is then encrypted using the recipient ID key 808. All of this encrypted data is then placed in the recipient transmission 90.

The following steps will describe the steps that are undertaken in method 900, that will generally take place at the recipient station 52. After the transmission is sent to the recipient as an e-mail message in step 932, method 900 then proceeds to step 934 wherein the encrypted session key 810, as had been shown in item 1765, is decrypted with the recipient's ID key 808. The encrypted session key is only able to be decrypted by the recipient's ID key 808. This ensures that a party that may have intercepted the transmission to the server is unable to subsequently view the contents of the transmission, as the recipient ID key 808 will be stored securely by the recipient station.

Method 900 will then proceed to step 936, where the session key 810, that has been decrypted in step 932, is now used decrypt the transmission containing the documents 20 and the encrypted session key as had been shown in FIG. 32 as element 1760.

Method 900 will then proceed to step 938, wherein the server public key 802 is used to decrypt the session key 810. If this decryption is successful, then the server 56 has been authenticated as the sender, thus ensuring that the recipient transmission 90 did not originated from an unauthorized source.

Method 900 may be used to transmit data of any variety, and method 900 has been illustrated here with an example of document transmittal only for purposes of illustration.

Reference is now made to FIG. 34, wherein the steps of a method, namely status reply method 950, are shown. Status reply method 950 is a method by which the sender's station 52 is provided evidence that the server 56 was in fact the recipient of the server transmission 78 and it was not received by an unauthorized party. Method 950 will be undertaken for every server transmission 78 that is received at the server 56.

Method 950 begins in step 951, wherein the server 56, which has received the server transmission 78 and performed the appropriate decryption which allows for the authentication of the sender, will create a status message which will include timestamps indicating the time at which transmissions were received, and may also include other information indicating, for example, that a virus may have been found, or that there is a key mismatch.

Method 950 then proceeds to step 954, wherein the status message is encrypted with the session key 810. The session key 810 is then encrypted with the server private key 804. The encrypted data resulting from step 954 is then transmitted to the sender in step 956 and is sent to the sender's station 52 via the HTTPS protocol, and more specifically the HTTPS return protocol.

Method 950 then proceeds to step 958, where the transmission of step 956 is received by the sender's station 52 and the session key 810 that has been retained is then used to decrypt the status message. The server public key 802 is then used in step 960 to decrypt the encrypted session key, thus ensuring that the transmission did in fact originate from the server 56.

Method 950 thus ensures that the sender's station 52 is provided with verification that the server transmission 78 was in fact received by the server 56, and was thus appropriately processed.

Records of every transmission that is sent and/or received by stations 52, which are part of the document transmission system 50, are stored upon each station 52 that has sent and/or received a transmission. The record module 66 will monitor all transmissions that are sent and or received by a station 52. Reference is made to FIG. 35, wherein a transmission database 77 is shown. Transmission database 77 will be stored upon a non volatile memory store that is connected to or located upon a station 52. The transmission database 77, in a preferred embodiment, will contain the following fields, a date sent/received field 1305, a document number field 1310, a document type field 1315, an inbound/outbound field 1320 and a from/to field 1325. The date sent/received field 1305 will record the exact date and time at which a transmission was sent and or received by the station 52. The document number field 1310 will contain the exact unique identification numbers that are used to delineate documents, such as, for example, purchase order numbers. The document type field 1315 will record the type of document that is associated with a particular document number, such as for example, a purchase order. The inbound/outbound field 1320 will record whether the transmission, that is being recorded, was sent from the station 52 or received at the station 52. The from/to field 1325 will record the recipient of the transmittal if it is being sent from the station 52, or the originator of the transmission, if it is being received at the station 52. The transmission record for a transmission database 77 is populated once the status message is received.

As has been described above, when a user wishes to transmit a document 20 to another user of the document transmission system 50, the intended recipient will receive various representations of the document 20. A human readable file 80, along with a machine readable file 82, are transmitted to the intended recipient. The method by which these respective files are created will now be described with respect to parsing method 1000. Before parsing method 1000 is able to create the respective files, it requires that a mapping of the document 20 has taken place, and the document field map 1800, and document section map 2000 have been created.

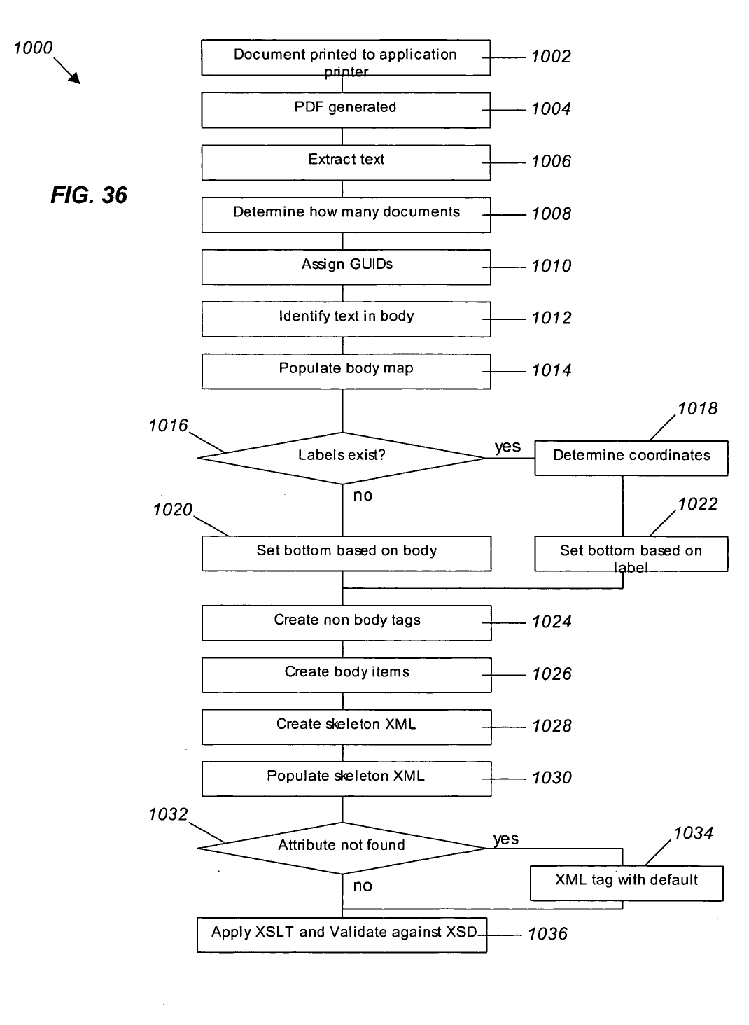

Reference is made to FIG. 36, where the steps of parsing method 1000 are shown in greater detail. Parsing method begins at step 1002, wherein after a user has created one or more documents 20 they wish to transmit via the document transmission system 50, the user prints the documents 20 to the document specific printer. Method 1000 then proceeds to step 1004 where based on the data stream that is sent to the document specific printer, a graphical image of the document 20 will be created, which is where the human readable file 80 will be created. Step 1004 is accomplished, in the preferred embodiment by means of a PDF generator as is known to one skilled in the art.

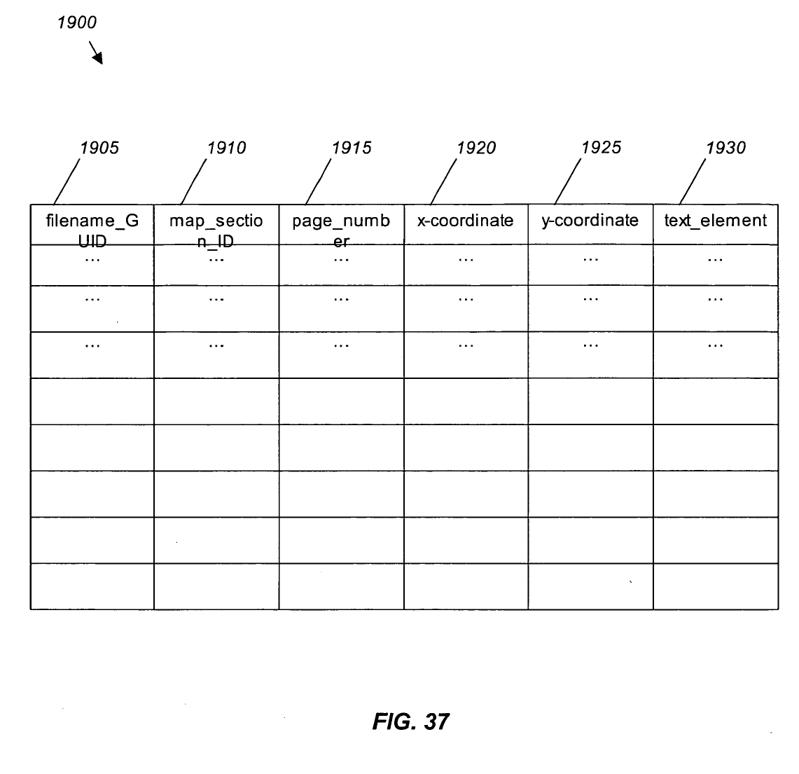

Parsing method 1000 will then proceed to step 1006, wherein, based on the human readable file 80 that has been created, the text contained on the document 20, and more specifically the human readable file 80 that has been created, will be extracted by a text extraction process that is undertaken. Reference is made to FIG. 37, wherein, an extracted text table 1900 is shown. Extracted text table 1900, in the preferred embodiment, will contain six fields, namely a filename_GUID field 1905, a map_section_ID field 1910, a page_number field 1915, an x-coordinate field 1920, a y-coordinate field 1925 and a text_element field 1930. Each word or group of strings, separated by a blank space, will be entered into the text_element field 1930, along with the corresponding x and y co-ordinates, which are entered into the x-co-ordinate and y-co-ordinate fields 1920 and 1925, respectively. The extracted text table 1900 is populated by means of text extraction tools, which are known in the art. The text extraction process that is undertaken in method 1000, provides the x and y co-ordinates of each word or string contained upon the document or documents the user is attempting to transmit.

Parsing method 1000 then proceeds to step 1008, wherein the unique document identifier that was specified by the user when the mapping of the document was undertaken is retrieved. The unique document identifier (i.e. such as a purchase order number) will be used in determining how many unique documents 20 the user wishes to transmit via the document transmission system 50. For example, as the user may have created more than one purchase order 100, it is imperative that the individual documents 20 that have been received be separated, such that appropriate file representations be created for each document 20. Parsing method 1000 determines exactly how many unique documents the user is attempting to transmit by means of searching the extracted text table 1900, to determine how many instances of the unique document identifier are found, thereby giving the number of unique documents that the user wishes to transmit via the document transmission system 50.

Parsing method 1000 then proceeds to step 1010, where a unique transmission ID, referred to as a GUID (globally unique ID), for each document the user wishes to transmit, is created. The GUID is created using a function that generates a unique code that cannot be replicated when the function is invoked again, thereby creating a truly unique ID. Parsing method 1000 will then populate the filename_GUID field 1905 with the GUID that is associated with each entry in the extracted text table 1900. As a GUID has been created for each document 20 the user is attempting to transmit, the filename_GUID field will be populated based on each document having one GUID. Therefore if the extracted text table 1900 contains the text from only one document 20, as the user is attempting to transmit only one document, the same GUID will be entered into the filename_GUID field 1905 for all entries.

Parsing method 1000 then proceeds to step 1012, wherein for the text that is contained in the extracted text table 1900, the map_section_ID field 1910 is populated. Based on the body co-ordinates, which have been recorded in the document section map 2000, each entry is analysed in the extracted text table 1900 to determine whether it falls in the body area. If the text does fall in the body area, the map_section_ID field is set to indicate that the text can be found in the body area.

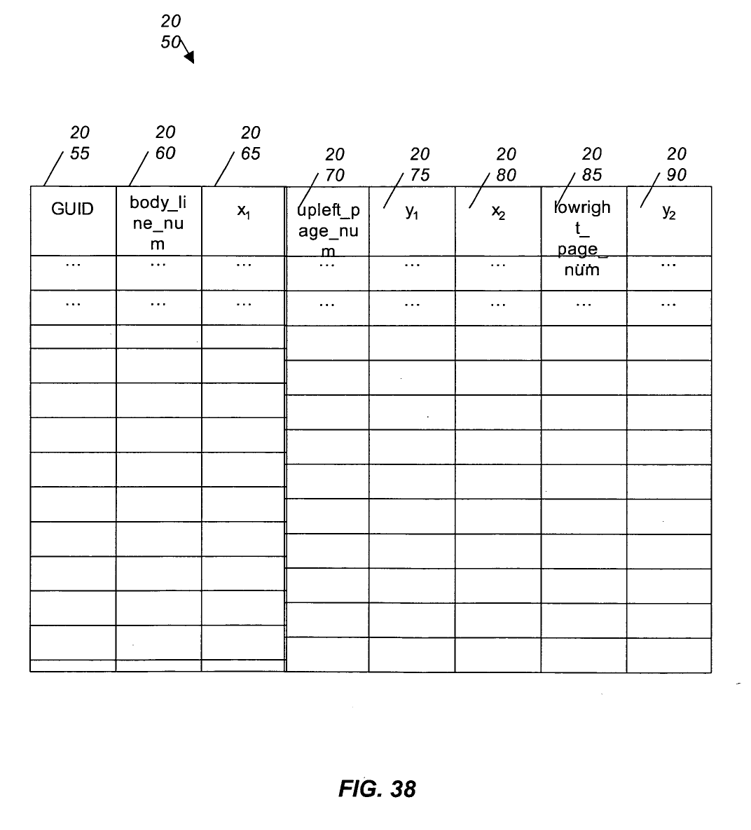

Parsing method 1000 then proceeds to step 1014 wherein a body map 2050 is created, as shown in FIG. 38, is populated. A body map 2050 contains numerous fields, namely, a GUID field 2055, a body_line_number field 2060, an x₁ field 2065, an up_left_page_num field 2070, a y₁ field 2075, an x₂ field 2080, a lowright_page_num field 2085 and a Y₂ field 2090. The body map 2050 will essentially provide the co-ordinates for each line that is contained within the body of a document, even where a line may begin on one page of the document and conclude on another. Based on the document section map 2000, the co-ordinates of the body area are known, therefore, the extracted text table 1900 is analyzed to determine how many instances of a unique line identifier are found within the respective body co-ordinates. The determination of how many instances of a unique line identifier are located will determine the number of lines of data within the body, and as a result an appropriate number of rows of data are populated in the document body map 2050. Based on the co-ordinates of the unique line identifier(s) that are found on each line, the appropriate x and y co-ordinate fields are populated on the document body map 2050

Parsing method 1000 then proceeds to step 1016, wherein a check is done to determine whether the user, when mapping the document, has done so by means of a label identifier, as was done in step 254. If a label identifier has been defined in step 254, then the respective y co-ordinate for it is determined by searching for the matching text within extracted text table1900, and specifically within text element field 1930 and, upon finding a match, retrieving y co-ordinate value stored in field 1925. Method 1000 then proceeds to step 1022, where the bottom of the body area as indicated by the last body_line_num in 2050 is set to be the y-coordinate determined in step 1018. Step 1022 has the effect of defining the bottom most area on a document body wherein information will be found. If in step 1016 it is determined that a label identifier has not been used, then the bottom of the body area is set to be the bottom y bound taken from the document body map 2050 in step 1020.

Method 1000 then proceeds to step 1024 wherein XML tags for attributes that are not found within the body are created. The content that is associated with an XML attribute is retrieved from the extracted text table 1900. Specifically, based on co-ordinates specified in the document field map 1800 for an attribute, the extracted text table 1900 is analyzed to determine which elements of text appear within a given co-ordinate set. Text that is found within text_element field 1930 that occurs within a set of co-ordinates is concatenated from left to right, proceeding downwards. This step is undertaken for all the attributes that are not part of the body area.

Method 1000 then proceeds to step 1026 wherein the XML tags for attributes that are found within the body are created. Based on the co-ordinates that have been specified in the document body map 2050, which specifies the coordinate range for each line within the body, the extracted text table 1900 is analyzed such that text that appears within the co-ordinate ranges for a line will be used to construct the text that is associated with a specific attribute. Specifically, text appearing within a co-ordinate range is concatenated in a left to right, top down manner.

At this point of method 1000, XML tags have been created for all attributes that are contained upon a document 20. Method 1000 then proceeds to step 1028 wherein a skeleton XML document is created based on the XSD that has been defined. Method 1000 then proceeds to step 1030 wherein the XML skeleton created in step 1028 is populated based on the XML tags that have been created in steps 1024 and 1026, respectively.

Method 1000 then proceeds to step 1032, when a check is done, to determine whether all attributes have had XML tags created for them based on text that has been taken from the extracted text table 1900. If any attributes have not had XML tags created for them, then method 1000 proceeds to step 1034 wherein the default value that is stored for this attribute is retrieved from the document field map 1800, and specifically the default field 1815.

Method 1000 proceeds, after the conclusion of step 1034, or after step 1032, to step 1036. Step 1036 involves optional XSLT processing, which may be carried out on the XML document that has been created, and validation of the final resultant XML document against its XSD.

At this point in parsing method 1000, the human readable file 80, and machine readable file 82 have been created, as such, the various representations may now be transmitted to the server 56.

The recipient address information is extracted and used as a look-up key to find the associated subscriber ID of the recipient as stored in 76. In this way, the user is not required to specify again who the intended recipient of the document is to be (aside from insuring it appears on the document 20).

The present invention has been described with regard to preferred embodiments. However, it will be obvious to persons skilled in the art that a number of variants and modifications can be made without departing from the scope of the invention as described herein.

1. A method of transmitting a data payload from a sender station to a recipient station comprising:
(a) assigning a sender ID key to one or more stations belonging to a sender;
(b) assigning a recipient ID key to one or more stations belonging to a recipient;
(c) assigning a server public key to a server;
(d) assigning a server private key to the server, wherein the server private key and the server public key are a complementary pair of keys;
(e) at the sender:
(i) generating a session key;
(ii) encrypting the session key with the server public key to produce a first sender encrypted session key;
(iii) encrypting the session key with the sender ID key to produce a second sender encrypted session key;
(iv) encrypting the data payload and the second encrypted session key with the session key to produce a sender encrypted payload;
(v) transmitting the sender encrypted payload and the first sender encrypted session key to the server;
(f) at the server:
(i) decrypting the first sender encrypted session key with the server private key to obtain a first server decrypted session key;
(ii) decrypting the sender encrypted payload with the first server decrypted session key to obtain the payload and the second sender encrypted session key;
(iii) determining the sender associated with the payload based on information transmitted from sender;
(iv) decrypting the second sender encrypted session key with the sender ID key to obtain a second server decrypted session key;
(v) comparing the first server decrypted session key to the second server decrypted session key;
(vi) if the result of the comparison is that the first and second server decrypted session keys are identical, then accepting the transmission as having originated from the sender station.

2. The method of claim 1 wherein, if the result of the comparison in (f)(v) is that the first and second server decrypted session keys are identical, then:
(g) at the server:
(vi) encrypting the session key with the recipient ID key to produce a first server encrypted session key;
(vii) encrypting the session key with the server private key to produce a second server encrypted session key;
(viii) encrypting the data payload and the second server encrypted session key with the session key to produce a server encrypted payload; and
(ix) transmitting the first server encrypted session key and the server encrypted payload to the recipient station; and
(h) at the recipient station:
(i) decrypting the first server encrypted session key with the recipient ID key to produce a first recipient decrypted session key;
(ii) decrypting the server encrypted payload with the session key to obtain the data payload and the second server encrypted session key;
(iii) decrypting the second server encrypted session key with the server public key to produce a second recipient decrypted session key; and
(iv) comparing the first recipient decrypted session key with the second recipient decrypted session key; and
(v) if the result of the comparison is that the first and second recipient decrypted session keys are identical, then accepting the data payload as having been sent from the server.

3. The method of claim 2 wherein the first sender encrypted session key and the sender encrypted payload may be compressed before transmission.

4. The method of claim 3 wherein the compressed first sender encrypted session key and the sender encrypted payload are decompressed upon receipt at the server.

5. The method of claim 2 wherein the first server encrypted session key and the server encrypted payload may be compressed before transmission.

6. The method of claim 5 wherein the compressed first server encrypted session key and the server encrypted payload are decompressed upon receipt at the recipient.

7. A method of transmitting documents from a sender station to a recipient station comprising:
(a) creating a document at a sender station and specifying recipient information upon said document;
(b) creating files representative of said document;
(c) identifying said recipient information upon said document;
(d) transmitting said representative files and said recipient information to a server.
(e) receiving said representative files and said recipient information at said server;
(f) determining at said server an electronic address associated with said recipient information; and
(g) transmitting from said server to a recipient said representative files via said electronic address.

8. The method of claim 7 including invoking a software application and wherein steps (b), (c) and (d) are performed by the software application.

9. The method of claim 7 where said representative files may be machine and/or human readable files.

10. The method of claim 7 wherein said electronic transmission means may be an e-mail address.

11. The method of claim 7 wherein said electronic transmission means may be an FTP address.

12. The method of claim 7 wherein said electronic transmission means may be associated with an TCP-IP address or transmission protocol.

13. A method of transmitting documents from a sender to a recipient comprising:
(a) creating a document at a sender station and specifying recipient information upon said document;
(b) creating a machine readable version of the document, wherein the machine readable version identifies the recipient based on the recipient information; and
(c) transmitting said machine readable version of the document, wherein said server receives said recipient information and said machine readable version and determines an electronic address associated with said recipient, and transmits said representative files to said recipient via said electronic transmission means.

14. The method of claim 13 further including creating a human readable file corresponding to the document and transmitting the human readable file with the machine readable file.

15. The method of claim 13 wherein said electronic transmission means may be an e-mail address.

16. The method of claim 13 wherein said electronic transmission means may be an FTP address.

17. The method of claim 13 wherein said electronic transmission means may be associated with a TCP-IP address or transmission protocol.

18. A method for creating a document map for a document, wherein the document is of a document type, the method comprising:
(a) defining a document schema, wherein the document schema contains attributes associated the document type
(b) mapping different regions of the document and correlating each mapped region to an attribute.

19. The method of claim 18 wherein one or more of the attributes may be assigned a default value.

20. The method of claim 18 wherein a mapped region on said document is defined by a relative position of an attribute.

21. A method of parsing a document to create a machine readable version of the document, the method comprising:
(a) receiving the document in an electronic form;
(b) extracting text elements of the document and recording the coordinates of each text element;
(c) comparing the coordinates of each extracted text element with regions defined in a document map; and
(d) identifying an attribute for each extracted text element based on the comparison; and
(e) recording each extracted text element according to its attribute in the machine readable file.

22. The method of claim 21 further comprising tagging each extracted text element according to its attribute and identifying each tagged extracted text elements together by its tag in the machine readable file.

23. The method of claim 21, wherein the tags are XML tags.

24. The method of claim 21, wherein the attributes in the machine readable file may be associated with a default value.
